(19) United States
(12) Patent Application Publication
(10) Pub. No.: US 2024/0283731 A1
(43) Pub. Date: Aug. 22, 2024

(54) PATH MANAGEMENT TECHNIQUES FOR NETWORK CONNECTIONS

(71) Applicant: Oracle International Corporation, Redwood Shores, CA (US)

(72) Inventors: Qiang Wang, Bellevue, WA (US); Kent Lee, Ladera Ranch, CA (US)

(73) Assignee: Oracle International Corporation, Redwood Shores, CA (US)

(21) Appl. No.: 18/649,290

(22) Filed: Apr. 29, 2024

Related U.S. Application Data
(63) Continuation-in-part of application No. 17/515,357, filed on Oct. 29, 2021, now Pat. No. 11,650,745.
(63) Continuation-in-part of application No. 17/698,987, filed on Mar. 18, 2022, now Pat. No. 12,021,757.
(63) Continuation-in-part of application No. 17/747,277, filed on May 18, 2022.

(51) Int. Cl. H04L 45/24; H04L 45/00

(52) U.S. Cl. CPC H04L 45/24; H04L 45/38

(57) ABSTRACT

The disclosed systems, methods and computer readable media relate to managing Non-Volatile Memory Express (NVMe) over Transmission Control Protocol (TCP) (NVMeOTCP) connections between a smart network interface card (smartNIC) and a block storage data plane (BSDP) of a cloud computing environment. A software agent (“agent”) executing at the smartNIC may manage a number of network paths (active and, in some cases, passive network paths). The agent may monitor the network traffic (e.g., input/output operations (IOPS)) through the paths (e.g., using established NVMeOTCP connections corresponding to the paths). If a condition is met relating to a heat threshold of an active path (e.g., the currently used network path), the agent may determine whether to failover and, if so, the agent may select a network path for failover. In some cases, this determination and potential selection may factor in heat measurements of the current and other available network paths.

### CROSS-REFERENCE TO RELATED APPLICATIONS

This application is a continuation-in-part of U.S. Non-Provisional patent application Ser. No. 17/515,357, filed on Oct. 29, 2021, entitled “Increased Data Processing Performance of a Non-Volatile Memory Express (NVME) Block Store,” U.S. Non-Provisional patent application Ser. No. 17/698,987, filed on Mar. 18, 2022, entitled “Bandwidth Control Inside a Shared Network Interface Card,” and U.S. Non-Provisional patent application Ser. No. 17/747,277, filed on May 18, 2022, entitled “A Single Hop Approach for Distributed Block Storage via a Network Virtualization Device,” the disclosure of which is herein incorporated by reference in its entirety for all purposes.

### BACKGROUND

Creating and running a cloud service can include connecting persistent storage (e.g., a block storage data plane (BSDP) component) to host instances (bare metal (BM) instances, virtual machine (VM) instances) via connections made by a smartNIC of the host instance. In some cases, the connections are Non-Volatile Memory Express over Transmission Control Protocol (NVMeOTCP) connections. In some cases, there are redundant network paths that may be used for failover purposes. By way of example, a current backend target server (e.g., one end of a connection) may fail due to physical network failures along the path or target restarts during patching deployments. As another example, the target server may underperform when running in a multi-tenant system due to a noisy neighbor effect. In these, and other, examples, one of the redundant network paths may be selected for failover. Conventionally, selecting one of these redundant network paths led to suboptimal results.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

At least one embodiment includes a method. The method may comprise managing, by a software agent at a smart network interface card of a cloud computing environment, managing, by a software agent at a smart network interface card of a cloud-computing environment, a set of network paths comprising an active network path and a plurality of passive network paths. In some embodiments, the active network path is associated with an established network connection between the smart network interface card and a first storage component of the cloud-computing environment. Each of the plurality of passive network paths may be associated with a respective storage component of the cloud-computing environment for which a network connection is currently unestablished. The method may further comprise determining, by the software agent executing at the smart network interface card, a rate of network traffic associated with the active network path. The method may further comprise obtaining, by the software agent, respective heat measurements (e.g., respective CPU utilization values) corresponding to the respective storage component for each of the plurality of passive network paths. The method may further comprise replacing, by the software agent executing at the smart network interface card, the active network path with a passive network path of the plurality of passive network paths based at least in part on the rate of network traffic and the respective heat measurement corresponding to the respective storage component for each of the plurality of passive network paths. In some embodiments, replacing the active network path causes a new network connection associated with the passive network path to be established between the smart network interface card and another storage component of the cloud-computing environment.

In some embodiments, replacing the active network path further comprises terminating the established network connection between the smart network interface card and the first storage component. The active network path may be replaced based at least in part on detecting that the established network connection between the smart network interface card and the first storage component has failed.

In some embodiments, the respective heat measurements may correspond to a percentage of central processing unit utilization of a central processing unit of the respective storage component for each of the plurality of passive network paths.

The method may further comprise selecting a first passive network path of the plurality of passive network paths to replace the active network path. In some cases, the first passive network path may be selected over a second passive network path of the plurality of passive network paths based at least in part on determining that a first heat measurement corresponding to the first passive network path is less than a second heat measurement corresponding to the second passive network path.

In some embodiments, the method may further comprise obtaining, by the software agent, a heat measurement for the active network path and calculating, by the software agent, a heat score (e.g., a normalized CPU utilization value) for the active network path. In some embodiments, the heat score may be calculated based at least in part on dividing the rate of network traffic by the heat measurement for the active network path. The active network path may be replaced based at least in part on determining that the heat score for the active network path exceeds a predefined threshold value.

A second method is disclosed herein. The second method may comprise managing, by a software agent executing at a smart network interface card, a plurality of network paths. Each network path of the plurality of network paths may be associated with a respective network connection between the smart network interface card and a respective storage component of a cloud-computing environment. The second method may comprise determining, by the software agent, a first value corresponding to a rate of network traffic through a network path of the plurality of network paths. The second method may comprise determining, by the software agent, a second value corresponding to a heat measurement (e.g., a CPU utilization value) associated with a storage component associated with the network path of the plurality of network paths. The second method may comprise diverting, by the software agent to the network path of the plurality of network paths, a portion of network traffic corresponding to a second network path of the plurality of network paths based at least in part on the first value and the second value.

In some embodiments, the second method may comprise determining, by the software agent, a third value corresponding to a second rate of network traffic through the second network path. The second method may comprise determining, by the software agent, a fourth value corresponding to a second heat measurement associated with a second storage component associated with the second network path. In some cases, diverting the portion of network traffic is further based at least in part on the third value and the fourth value.

In some embodiments, the second method may further comprise determining, by the software agent, a third value corresponding to a second rate of network traffic through a third network path of the plurality of network paths and determining, by the software agent, a fourth value corresponding to a second heat measurement associated with a second storage component associated with the third network path. In some cases, diverting the portion of network traffic is further based at least in part on the third value and the fourth value.

In some embodiments, each of the plurality of network paths may be an active network path of a respective network path group. The respective network path group may further comprise one or more passive network paths, each of the one or more passive network paths being associated with a corresponding network connection between the smart network interface card and a corresponding storage component of the cloud-computing environment, the respective network connection being unestablished.

In some embodiments, each of the plurality of network paths is an active network path associated with a corresponding network path group of a plurality of network path groups. The active network path may have an established network connection between the smart network interface card and a corresponding storage component of the cloud-computing environment.

Some embodiments include a smart network interface card (smartNIC). The smartNIC may include one or more processors and one or more memories configured to store computer-executable instructions that, when executed by the one or more processors, cause the one or more processors to execute operations. These operations may comprise any suitable method described herein.

In some embodiments, the operations are executed by a software agent of the smart network interface card.

In some embodiments, the smartNIC may calculate a first heat score (e.g., a normalized CPU utilization value) for a first passive network path of the plurality of passive network paths. The first heat score may be calculated based at least in part on the rate of network traffic and a first heat measurement of the respective heat measurements. The first heat measurement may correspond to a second storage component of the cloud-computing environment. The smartNIC may calculate a second heat score for a second passive network path of the plurality of passive network paths, where the second heat score may be calculated based at least in part on the rate of network traffic and a second heat measurement of the respective heat measurements. In some cases, the second heat measurement may correspond to a third storage component of the cloud-computing environment. The passive network path that replaces the active network path may be identified as the first passive network path based at least in part on the first heat score and the second heat ratio. In some embodiments, the respective heat measurements are obtained based at least in part on obtaining respective central processing unit utilization values corresponding to the respective storage component for each of the plurality of passive network paths.

In some embodiments, the operations performed by the smartNIC may further comprise receiving, from an initiator of the smart network interface card, an indicator that the second network path of the plurality of network paths has failed. In some embodiments, the second value corresponding to the heat measurement associated with the storage component is determined based at least in part on receiving the indicator.

In some embodiments, the second network path is an active network path of a network path group, and the network path to which the portion of network traffic is diverted is a passive network path of the network path group. In at least one embodiment, the second network path is a first active network path of a first network path group and the network path to which the portion of network traffic is diverted is a second active network path of a second network path group.

In some embodiments, the operations performed by the smartNIC may further comprise determining an amount corresponding to the portion of network traffic diverted to the second network path based at least in part on a second amount of network traffic previously associated with the second network path.

### BRIEF DESCRIPTION OF THE DRAWINGS

FIG. 1 is a simplified control path diagram showing cloud infrastructure components for attaching Block Storage Data Plane (BSDP) persistent storage, according to an embodiment.

FIG. 2 is a diagram showing a kernel architecture for implementing Internet Small Computer Systems Interface (iSCSI) and Non-Volatile Memory Express (NVMe) attachments, according to an embodiment.

FIG. 3 is a Non-Volatile Memory Express (NVMe) system diagram, according to an embodiment.

FIG. 4 is a diagram of a Non-Volatile Memory Express (NVMe)/Transmission control Protocol (TCP) target, according to an embodiment.

FIG. 5 is a simplified diagram of a smart network interface card (smartNIC) with Non-Volatile Memory Express (NVMe), according to an embodiment.

FIG. 6 is a diagram showing multipath handling in a smart network interface card (smartNIC), according to an embodiment.

FIG. 7 shows a diagram of an architecture for performing encryption/decryption with a smart network interface card (smartNIC), according to an embodiment.

FIG. 8 is a diagram of another example showing network connection management by a smart network interface card (smartNIC), according to an embodiment.

FIG. 9 is a diagram of yet another example showing network connection management by a smart network interface card (smartNIC), according to an embodiment.

FIG. 10 is a flow diagram illustrating an example process for managing network connections utilized between a smartNIC and a data plane resource of a cloud computing environment, according to an embodiment.

FIG. 11 is a flow diagram illustrating another example process for managing network connections utilized between a smartNIC and a data plane resource of a cloud computing environment, according to an embodiment.

FIG. 12 is a block diagram illustrating an example method for managing network paths between a smartNIC and a resource of a cloud computing environment, according to an embodiment.

FIG. 13 is a block diagram illustrating another method for managing network paths between a smartNIC and a resource of a cloud computing environment, according to an embodiment.

FIG. 14 is a block diagram illustrating one pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to managing Non-Volatile Memory Express (NVMe) over Transmission Control Protocol (TCP) connections (“NVMeOTCP”) between NVMe components executing at a smart network interface card (smartNIC) of a host machine of a cloud computing environment, and data plane components/resources (e.g., target servers serving as data endpoints for a block storage fleet of servers). By way of example, a smartNIC may be used to manage NVMeOTCP connections with block storage data plane components. NVMe, and other networking protocols such as iSCSI, may be used to provide block-level storage access between a host machine (e.g., via a smartNIC) and a Block Storage Data Plane (BSDP) persistent storage. A “smartNIC” refers to a type of network interface card that includes one or more on-board processors and is configured with computing components for network protocol management and, potentially, any suitable combination of programmable compute, one or more security component (e.g., cryptographic operations for performing encryption/decryption), and/or one or more storage components. In some embodiments, the smartNICs utilized in the examples herein utilize NVMe and/or another networking protocol, to enable access to BSDP persistent storage access through the smartNIC of a host machine. These BSDP, and other data plane resources, are collectively referred to as “data plane resources” or “resources,” for brevity.

Conventional techniques did not factor in CPU usage being expended by the backend resources. As computing components utilize higher CPU, they can fail or incur component damage. Therefore, ensuring these components do not experience unnecessarily high CPU usage ensures more optimal performance of the system as a whole. Conventionally, failovers were neither triggered, nor managed, based on CPU usage or other inputs (e.g., CPU related data) from the backend resources. This enabled components with relatively high CPU usage to be utilized despite other components with relatively low CPU usage to remain underutilized. When failures were triggered for a variety of purposes, a replacement network path was not selected based on CPU utilization. This allowed a sub-optimal network path to be selected to replace a previously failed path. By failing to factor in the data from these backend resources, sub-optimal replacements could be selected, resulting in an increased risk of performance degradation, which in turn wastes system resources processing solutions to the degraded performance. Such systems could experience a heightened failover rate, resulting in increased disruption of customer workloads.

Techniques discussed herein are directed to managing NVMeOTCP connections between the smartNIC and backend resources (e.g., targets/endpoints of the block storage data plane) based at least in part on the CPU utilization of each backend resources. In some embodiments, a failover may be triggered when the CPU utilization at a particular backend resource (e.g., a particular target server corresponding to a Block Storage Data Plane (BSDP) component) breaches a predefined threshold. The disclosed system may detect this condition and execute operations to select a replacement network path that utilizes a target server with lower CPU utilization. In some embodiments, selecting a network path, in general, may factor in the CPU utilization by the backend resources (e.g., the target servers serving as gateways to a BSDP component) such that a least heat producing target server may be selected over target servers that are currently utilizing higher CPU processing resources. In some embodiments, the amount of network traffic being processed through each network path and processing unit measurements may be utilized as input to a heat function to normalize the measurements and to determine which network paths may be selected. The disclosed techniques provide for a more optimal selection criteria when 1) identifying that a failover event of a currently active network path is occurring and 2) determining which target server to select as the new active network path during a failover. By using processing unit measurements and (and/or computed heat values), performance of the system as a whole is improved by reducing the risk of degraded performance and needless failovers.

### Non-Volatile Memory Express (NVMe) System Background

Creating and running a cloud service can include mounting and connecting persistent storage (e.g., a block storage data plane (BSDP) component) to cloud instances. The persistent storage can be created, using a console or application programming interface (API), and linked to cloud instances (e.g., a virtual machine (VM) host or a bare metal (BM) host machine running in the cloud). Linking, or attaching, persistent storage of a block storage data plane to a cloud instance can be performed using a communication protocol. The attached storage can communicate with the cloud instance's guest operating system (OS) using the protocol.

Connections between a cloud instance and persistent storage within the block storage data plane (“BSDP persistent storage,” for brevity) are flexible and a number of configurations are possible. For instance, the BSDP persistent storage can be attached to one or more cloud instances simultaneously. The data in the BSDP persistent storage is durable and the storage can retain data after an attachment to a cloud instance is removed. Data can be migrated between instances by detaching BSDP persistent storage from one cloud instance and attaching the BSDP persistent storage to a second instance.

Durable BSDP persistent storage can allow for instance scaling. A cloud instance can be deleted without destroying or reformatting the corresponding BSDP persistent storage. After the cloud instance is deleted, the BSDP persistent storage can be attached to a new instance. The new instance can be created with a different instance type or shape. For example, the new cloud instance can be a VM or a BM regardless of the deleted instance's type. Additionally, the number of cores in a cloud instance can be changed by deleting an initial instance and creating a new instance with a different number of cores.

A transfer of data through an attachment can be started with an endpoint called an initiator. Data can be sent from the initiator to an endpoint of the BSDP persistent storage that can receive data. This endpoint is referred to as “a target.” An agent can set up the target to receive data and forward the data to the target. A number of advantages can be provided by locating the initiator in a smart network interface card (smartNIC). A user may need to provide login information or other configuration from the cloud instance if the initiator is located in the instance. Additionally, it can be difficult to keep the initiator functional across different guest OS types and OS versions. Locating the initiator in the smartNIC can also free customer resources that would be used to run the initiator.

Attachments can be provided using storage networking standards including Internet Small Computer Systems Interface (iSCSI), paravirtualized (PV) iSCSI, and Non-Volatile Memory Express (NVMe). iSCSI can provide attachments for bare metal (BM) devices with the initiator running from inside a customer instance. The initiator for PV iSCSI attachments can be set up and run inside a cloud instance's hypervisor, and PV iSCSI attachments can be limited to running on virtual machines (VM). The initiator for NVMe attachments can be run on a smartNIC. Accordingly, NVMe attachments can provide attachments for both VM and BM networks.

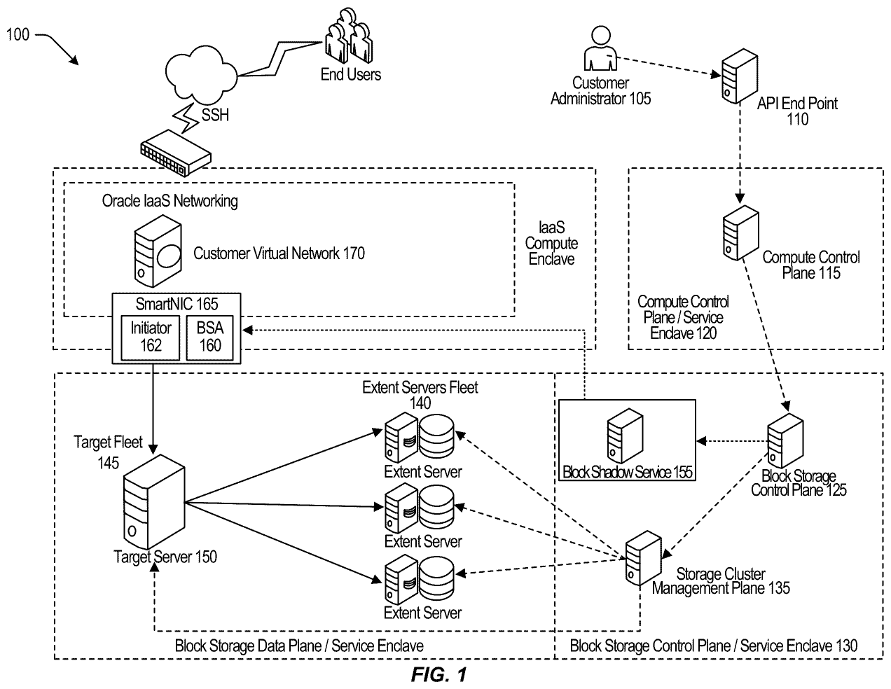

FIG. 1 is a simplified control path diagram 100 showing cloud infrastructure components for attaching BSDP persistent storage, according to an embodiment, for example, using NVMe. A customer administrator 105 can submit a request for a new storage attachment at an application programming interface (API) endpoint 110. In some examples, the customer administrator 105 may be any entity that manages or otherwise administers the use of cloud instances for a customer of the cloud service. In some instances, the API endpoint 110 may be an interface where customer's (e.g., customer administrator 105) can access the cloud service resources, for example, by making requests to have operations performed by the cloud service on resources managed for the customer. The request can be forwarded to the compute control plane 115 in a compute control plane service enclave 120. In some instances, compute control plane 115 can be a series of APIs that can provision, manage, reconfigure, or terminate resources based on user requests. The request can be forwarded from compute control plane 115 to the block storage control plane 125 in the block storage control plane enclave 130. In some examples, the block storage control plane 125 can be a series of APIs that can provision, manage, reconfigure, or terminate block storage.

A request that is received at block storage control plane 125 can be forwarded to the storage cluster management plane 135. Storage cluster management plane 135 can manage server fleets, and, for example, storage cluster management plane 135 can manage extent servers fleet 140 and target fleet 145. In some examples, storage cluster management plane 135 can configure and monitor extent servers fleet 140 or target fleet 145, and extent servers fleet 140 can include servers storing striped and encrypted customer data. Extent servers fleet 140 may be an example of BSDP persistent storage. Volumes can be striped across multiple extent servers in extent servers fleet 140. Extent servers can be part of a block storage data plane service that handles extent-level I/O and stores the data for replication. In response to the request, storage cluster management plane 135 can identify at least one target server 150 in the target fleet 145 as a target server for the attachment (e.g., a target server to which initiator 162 is to connect). In some instances, target server 150 can be a server that manages the flow of customer data to and from extent servers fleet 140. Target server 150 can accept I/O requests from an NVMe initiator (e.g., initiator 762) operating at smartNIC 165 and send the requests to extent servers fleet 140. The storage cluster management plane 135 can select the target server 150 based at least in part on the load experienced by the servers in the target fleet 145, or the expected volume for the attachment. Storage cluster management plane 135 can forward information about the new attachment to the selected target server 150 or the extent server fleet 140. The information can identify one or more target servers that are able to receive traffic from the new attachment.

The request can be forwarded from block storage control plane 125 to the block shadow service 155. The block shadow service 155 can act as an agent, and block shadow service 155 can communicate with the block smartNIC agent (BSA) 160 in smartNIC 165. In some examples, smartNIC 165 can be hardware that can connect the customer virtual network 170 to other computer networks. BSA 160 can serve as a communication link between block shadow service 155 and an NVMe agent in smartNIC 165. Communication from the block shadow service 155 can provide information about the target server and the attachment to BSA 160. A connection between the customer virtual network 170 and target fleet 145 can be established by BSA 160. BSA 160 can expose a namespace to the host through host PCIe connection, which can be accessed by the host applications and by the customer through the customer virtual network 170. The customer virtual network 170 can be set up by the VCN, and traffic from customer virtual network 170 can reach extent servers fleet 140 via target fleet 145 through smartNIC 165.

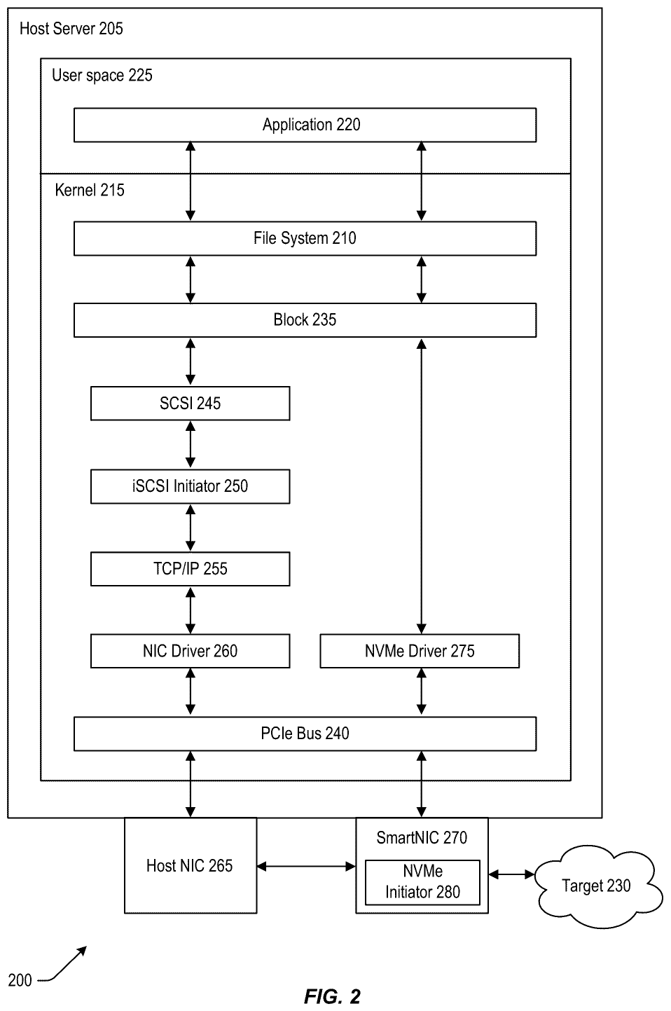

FIG. 2 is a diagram 200 showing a kernel architecture for implementing Internet Small Computer Systems Interface (iSCSI) and Non-Volatile Memory Express (NVMe) attachments according to an embodiment. NVMe and iSCSI are networking protocols providing block-level storage access, and both NVMe and iSCSI can be used to attach BSDP persistent storage. One difference between the two standards is that, in an iSCSI architecture, Input/Output (I/O) requests reach a smartNIC via a host network interface card (NIC), and, in an NVMe architecture, the smartNIC is directly connected to a Peripheral Component Interconnect Express (PCIe) bus. The NVMe kernel stack can be streamlined compared to the iSCSI stack, and NVMe's simplified architecture can be achieved because the NVMe initiator (e.g., initiator 162 of FIG. 1) can be located in the smartNIC 270.

In a host server 205, using either networking protocol, traffic can reach a file system 210 in the kernel 215 from an application 220 in the user space 225. The traffic can be addressed to a target 230 that can be a block storage server (e.g., target fleet 145, extent servers fleet 140, etc.). Traffic for the two standards can follow similar pathways until the traffic arrives at block 235 from file system 210.

Using iSCSI, traffic from block 235 reaches the PCIe bus 240 via SCSI 245, iSCSI initiator 250, TCP/IP 255, and the NIC driver 260. iSCSI traffic leaving PCIe bus 240 can reach the target via host NIC 265 and smartNIC 270. In some instances, PCIe bus 240 can be a serial computer expansion bus. The NVMe pathway can follow a different pathway, and NVMe traffic can reach PCIe bus 240 from block 235 via NVMe driver 275. Instead of passing through host NIC 265, NVMe traffic can travel from PCIe bus 240 to smartNIC 270 before reaching target 230. The NVMe initiator 280 can be located in smartNIC 270 instead of being located in kernel 215 like iSCSI initiator 250.

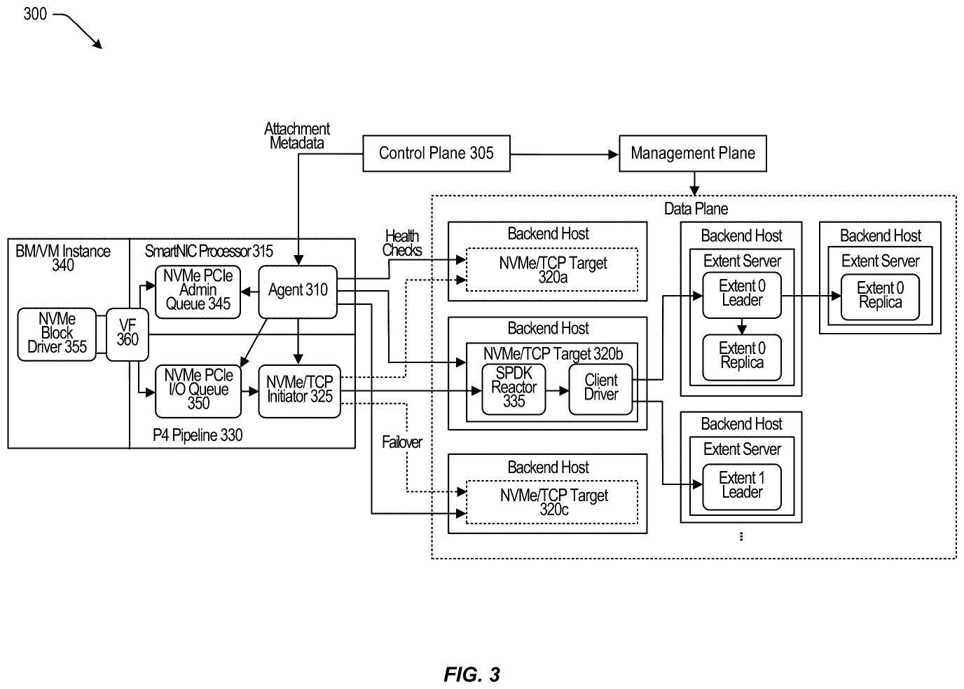

FIG. 3 is a Non-Volatile Memory Express (NVMe) system diagram 300 according to an embodiment. A customer, such as customer administrator 105, can initiate an NVMe attachment request from the console or a public API (e.g., API endpoint 110). The NVMe attachment request can be forwarded from the control plane 305 (e.g., block storage control plane 125) to an agent 310 (e.g., BSA 160) in the smartNIC processor 315. The agent 310 can perform health checks on NVMe/TCP targets 320a-320c to identify healthy targets, and agent 310 can instruct the NVMe/TCP initiator 325 in the Programming Protocol-Independent Packet Processors (P4) pipeline 330 to establish a connection with a healthy NVMe/TCP target (e.g., NVMe/TCP target 320b). P4 is a domain-specific programming language that is optimized for controlling packet forwarding. NVMe/TCP initiator 325 can communicate with Storage Performance Development Kit (SPDK) reactor 335 to initiate the connection (e.g., a NVMe/TCP connection). An NVMe/TCP connection refers to a TCP connection with which data provided according to an NVMe protocol that is wrapped/bound to a TCP message-based fabric.

Once a connection is established with NVMe/TCP target 320b and the NVMe attachment is completed, virtual machine/bare metal (VM/BM) instance 340 can issue NVMe admin commands or NVMe I/O commands to the NVMe/TCP target 320b. The NVMe commands can be issued from VM/BM instance 340 to NVMe PCIe admin queue 345 or NVMe PCIe I/O queue 350 via NVMe block driver 355 and virtual function (VF) 360. In some examples, VF 360 can be a PCIe function that supports single root I/O visualization (SR-IOV). In some instances, the admin queue can be used to establish host-controller associations and the queue can support commands like Identify, Get/Set Features, etc. Agent 310 can retrieve NVMe admin commands from the NVMe PCIe admin queue 345 and forward those commands to NVMe/TCP target 320b via a TCP connection using an NVMe specification that maps an NVMe storage access and transport protocol to message-based fabrics using TCP, or the commands can be processed locally. I/O commands received from VM/BM instance 340 can be enqueued into NVMe PCIe I/O queue 350. NVMe block driver 355 (e.g., NVMe driver 275) can retrieve the enqueued commands from NVMe PCIe I/O queue 350 to NVMe/TCP target 320b via NVMe/TCP initiator 325.

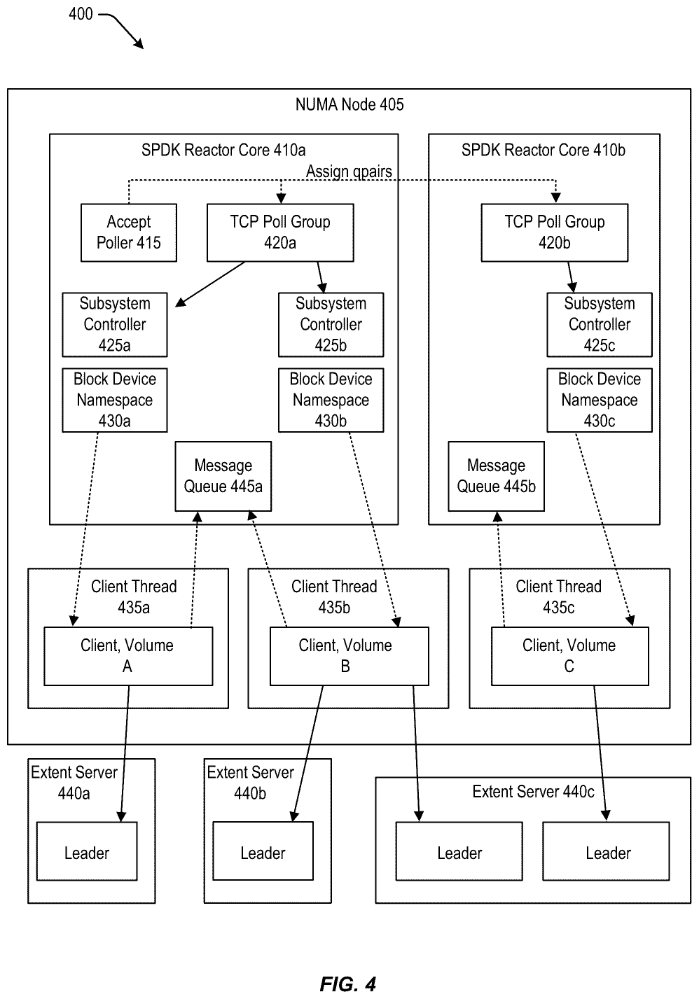

FIG. 4 is a diagram 400 of a Non-Volatile Memory Express (NVMe)/Transmission Control Protocol (TCP) target according to an embodiment. The NVMe/TCP target (e.g., NVMe/TCP target 320b) can be a Non-Uniform Memory Access (NUMA) node 405 that can include a central processing unit coupled with memory. Cores in the NUMA node 405 CPU can be assigned to one or more SPDK reactor cores such as SPDK reactor cores 410a-410b (e.g., SPDK reactor 335). Accept poller 415 can accept new connections to the SPDK reactor and assign the new connections to a SPDK reactor core (e.g., SPDK reactor core 410a). Accept Poller 415 can assign new connections to an available TCP poll group 420a-b in an available SPDK reactor core 410a-410b, and the new connections can be assigned using a round robin algorithm.

Subsystem controllers 425a-c can be assigned to a new connection, and, for example, subsystem controller 425a can be assigned for a connection made with TCP poll group 420a. More than one subsystem controller 425a-c can be assigned to one of the TCP poll groups 420a-b, and, for instance, subsystem controller 425a and subsystem controller 425b can be assigned to TCP poll group 420a. Block device namespaces 430a-430c can be generated when a connection is made with one of the subsystem controllers 425a-c.

Threads in a NUMA node CPU can be assigned as client threads 435a-c by one of the block device namespaces. Block device namespaces 430a-430c can forward a request that is received through the new connection to one of the client threads 435a-c, and client threads 435a-c can decide which extent server 440a-440c should receive the data associated with the request. After completing the request, client threads 435a-c can send a response to message queue 445a-b to indicate that a request has been completed. Requests can be received at a SPDK reactor core 410a-410b from the smartNIC initiator (e.g., NVMe/TCP initiator 325, NVMe initiator 280, initiator 162, etc.) or a different initiator. Responses can be sent from one of the SPDK reactor cores 410a-410b to the smartNIC initiator or a different initiator.

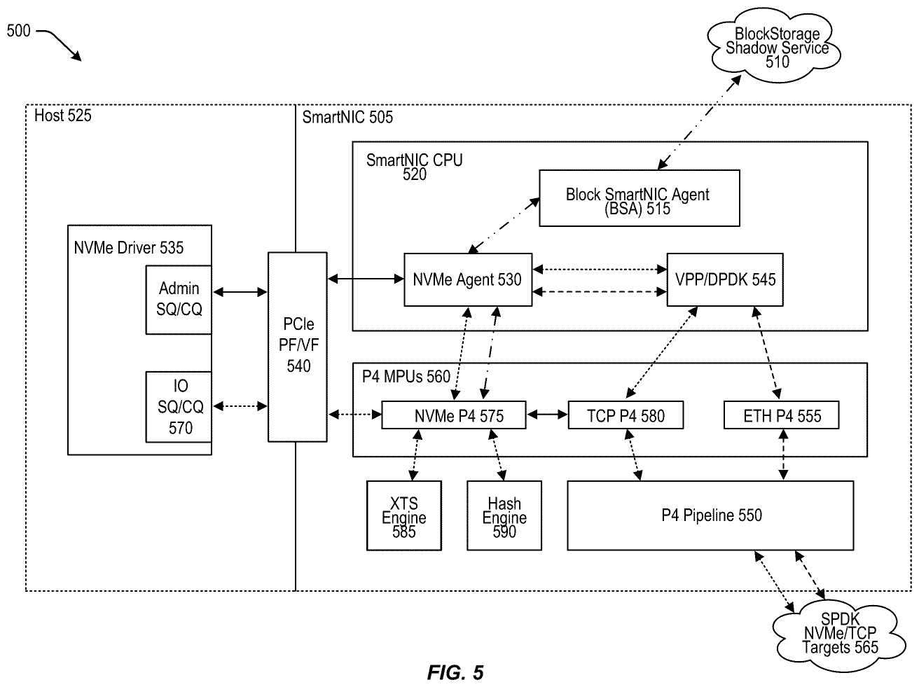

FIG. 5 is a simplified diagram 500 of a smart network interface card (smartNIC) with Non-Volatile Memory Express (NVMe) according to an embodiment. Requests can be received at smartNIC 505 from the block storage shadow service 510 (e.g., block shadow service 155) in the control plane (e.g., block storage control plane 125, control plane 305, etc.). The requests can be received at the block smartNIC agent (BSA) 515 (e.g., BSA 160) running on the smartNIC central processing unit (CPU) 520. BSA 515 can serve a number of functions including performing health checks, ensuring that targets are available, or performing telemetry. BSA 515 forwards instructions or requests to the host 525, or other smartNIC components, via NVMe Agent 530. Requests or instructions can be sent from NVMe Agent 530 to the NVMe driver 535 via a PCIe physical function or virtual function (PF/VF) 540 (e.g., VF 360).

The NVMe agent 530 can establish a new I/O connection in response to a request from BSA 515 using the vector packet processing/data plane development kit (VPP/DPDK) module 545. The VPP/DPDK module can use a framework, such as VPP with the DPDK plugin, to process and route network packets. In some embodiments, the VPP/DPDK module can use another suitable packet processing framework or functionality different from the framework or functionality of vector packet processing using the DPDK plugin. Upon receiving a request from NVMe agent 530, VPP/DPDK 545 can send a request to the P4 pipeline 550 (e.g., P4 pipeline 330) via the Ethernet (ETH) P4 module 555 running on the P4 match protection unit (MPU) 560. P4 pipeline 550 can establish an I/O connection with SPDK NVMe/TCP targets 565 (e.g., target 230, target fleet 145, NVMe/TCP target 320a-320c, etc.). Establishing a connection can include sending instructions to NVMe driver 535 or SPDK NVMe/TCP targets 565.

The I/O communication can be offloaded to a fast path I/O pipeline after an I/O connection is established with an SPDK NVMe/TCP target 565. The I/O fast path traffic can travel along the fast path pipeline from the I/O submission queue/completion queue (SQ/CQ) 570 in host 525 to P4 MPUs 560 via PCIe PF/VF 540. I/O traffic can be received in P4 MPUs 560 at NVMe P4 575 and forwarded to the SPDK NVMe/TCP targets 565 via TCP P4 580 and P4 pipeline 550. Traffic in I/O SQ/CQ 570 can start from the submission queue and end at the completion queue when I/O completes. If traffic along the fast path pipeline fails, NVMe P4 575 or TCP P4 580 can inform NVMe Agent 530 of the failure. NVMe agent 530 can be configured so that NVMe agent can create a new I/O connection in response to the failure and offload the new connection to the fast path pipeline. XTS engine 585 is an encryption engine that can encrypt user data using the xor-encrypt-xor (XEX)-based tweaked-codebook mode with ciphertext stealing (XTS) block cypher, and hash engine 590 can use cryptographic hash functions to verify data integrity.

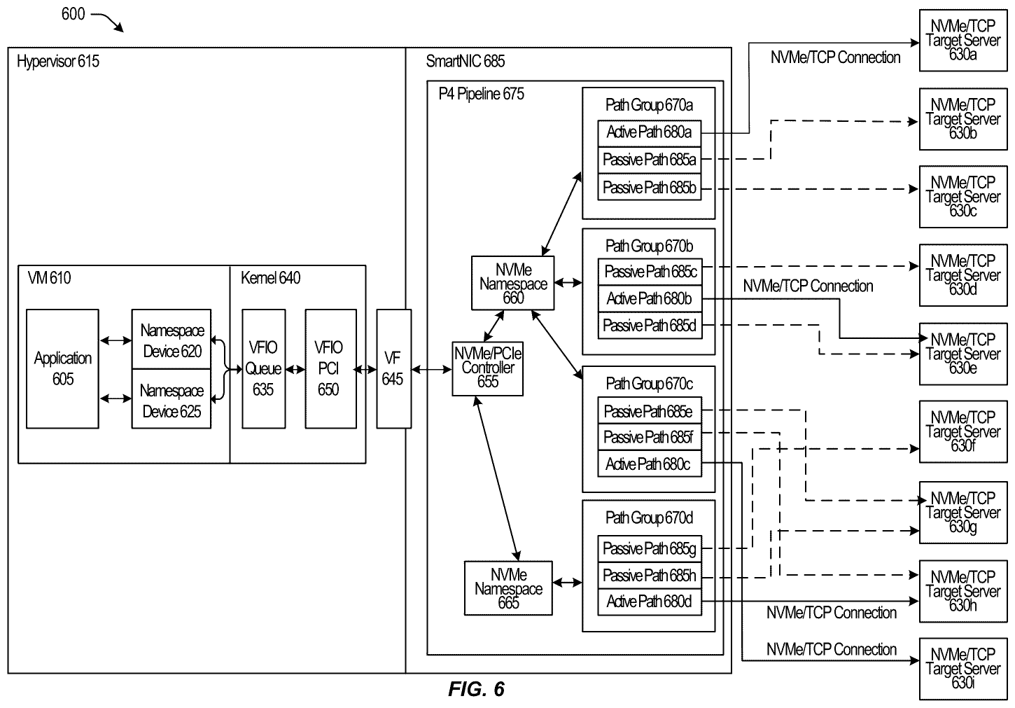

FIG. 6 is a diagram 600 showing multipath handling in a smart network interface card (smartNIC) according to an embodiment. An application 605 can run in a virtual machine (VM) 610 managed by a hypervisor 615. Application 605 can be similar to application 220, and VM 610 can be a bare metal machine (e.g., VM/BM instance 340). Two namespace devices, namespace device 620 and namespace device 625, can be associated with Application 605. A namespace can be a NVM storage that is formatted for block access. A namespace can be analogous to a logical unit in SCSI, and a block storage volume can be a single namespace. Traffic between namespace device 620 or namespace device 625 and the NVMe/TCP target servers 630a-i (e.g., target server 150) can be received via the virtual function Input/Output queue (VFIO) 635 in the kernel 640. The virtual function (VF) 645 can be connected to VFIO queue 635 via the VFIO peripheral component interconnect (PCI) 650. VF 645 can be a virtual function or a physical function.

The NVMe/PCIe controller 655 (e.g., NVMe P4 1575) can route traffic from the namespace devices 620 and 625 to NVMe namespaces. For instance, traffic can be routed between namespace device 620 and NVMe namespace 660, and traffic can be routed between namespace device 625 and NVMe namespace 665. The NVMe namespaces can be associated with one or more path groups 670a-d located in the P4 pipeline 675 (e.g., P4 pipeline 550, P4 MPUs 560, etc.) in smartNIC 680 (e.g., smartNIC 165, smartNIC 270, smartNIC 505, etc.). For instance, NVMe namespace 660 can route traffic to path groups 670a-670c, and NVMe namespace 665 can route traffic to path group 670d.

Path groups can include an active path 680a-d and one or more passive paths 685a-685h. Active paths 680a-d or passive paths 685a-685h can be associated with a NVMe/TCP target server 630a-i. Traffic between a NVMe/TCP target server 630a-i and namespace device 620 or namespace device 625 can be routed via active paths 680a-d. NVMe/TCP target servers 630a-i can route traffic to and from extent servers (e.g., extent servers fleet 140, extent servers 440a-440c, etc.).

Traffic can be routed via a passive path 685a-685h if an active path 680a-d fails. In response to a failure, data associated with passive path 685a-685h can be used (e.g., NVMe Agent 530, initiator 162, etc.) to login to an extent server via NVMe/TCP target servers 630a-630h. The extent server can change a token from the token associated with an active path 680a-d to a token associated with a passive path 685a-685h. The extent server can use the token to determine whether to accept traffic from a path (e.g., active paths 680a-d or passive paths 685a-685h).

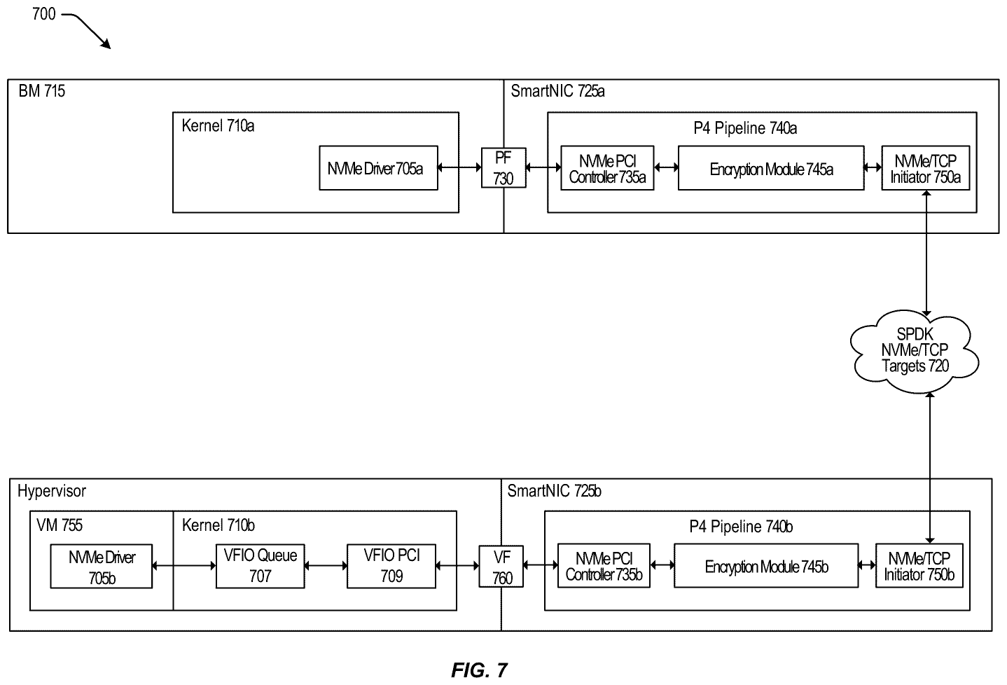

FIG. 7 shows a diagram of an architecture 700 for performing encryption/decryption with a smart network interface card (smartNIC) according to an embodiment. The architecture 700 can provide a unified means for encrypting/decrypting both VM and BM traffic. NVMe driver 705a (e.g., NVMe driver 275) can run in the kernel 710a of a bare metal (BM) machine 715 (e.g., VM/BM instance 340, etc.). Traffic can be sent from NVMe driver to SPDK NVMe/TCP targets 720 via smartNIC 725a. The BM traffic can be received via a physical function (PF) 730 (e.g., PCIe PF/VF 540, etc.) at the NVMe PCI controller 735a (e.g., NVMe/PCIe controller 655, NVMe P4 575, etc.) in the P4 pipeline 740a (e.g., P4 MPUs 560, P4 pipeline 550, etc.).

Outgoing BM traffic traveling from NVMe driver 705a to SPDK NVMe/TCP targets 720 can be encrypted by the encryption module 745a in smartNIC 725a, and incoming BM traffic can be decrypted by the encryption module 745a. Encryption module 745a can encrypt or decrypt traffic using an encryption algorithm such as Advanced Encryption Standard (AES). The encrypted BM traffic can be sent to SPDK NVMe/TCP targets 720 via the NVMe/TCP initiator 750a (e.g., NVMe initiator 280, NVMe/TCP initiator 325, NVMe Agent 530, etc.). Incoming encrypted BM traffic from SPDK NVMe/TCP targets 720 can be received at NVMe/TCP initiator 750a before being forwarded along the pathway to NVMe driver 705a. Incoming encrypted BM traffic can be decrypted by the encryption module 745a.

Outgoing VM traffic can be sent from NVMe driver 705b in the virtual machine (VM) 755 (e.g., VM/BM instance 340, VM 610, etc.) to the virtual function Input/Output (VFIO) Queue 707 (e.g., VFIO Queue 635) in kernel 710b and on to a virtual function (VF) 760 (e.g., VF 360, VF 645, etc.) via a VFIO PCI 709 (e.g., VFIO PCI 650). The outgoing VM traffic can be forwarded to NVMe PCI controller 735b (e.g., NVMe/PCIe controller 655, NVMe P4 575, etc.) in the P4 pipeline 740b (e.g., P4 MPUs 560, P4 pipeline 550, etc.). The outgoing VM traffic can be forwarded from smartNIC 725b to SPDK NVMe/TCP targets 720 via encryption module 745b and NVMe/TCP initiator 750b (e.g., NVMe initiator 280, NVMe/TCP initiator 325, NVMe Agent 530, etc.). Incoming VM traffic from SPDK NVMe/TCP targets 720 can be received at NVMe/TCP initiator 750b (e.g., NVMe initiator 280, NVMe/TCP initiator 325, NVMe Agent 530, etc.) before the incoming traffic is forwarded along the pathway to NVMe driver 705b. Incoming encrypted VM traffic can be decrypted by the encryption module 745a.

### NMVe Network Connection Management

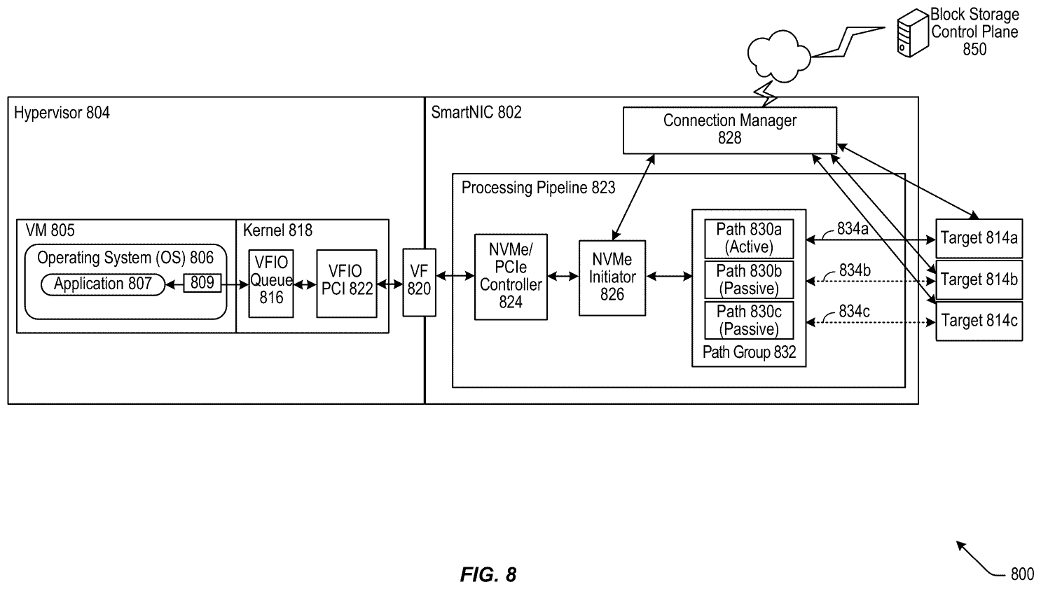

FIG. 8 is a diagram 800 depicting another example showing network connection management by a smart network interface card (smartNIC) 802 (an example of smartNIC 685 of FIG. 6), according to an embodiment. Although examples in the following figures utilize NVMe over TCP network connections, it should be appreciated that any suitable protocol may be used. By way of example, the network connections of any figure herein may be NVMe over Random Direct Memory Access (RDMA) and similar techniques as described herein may be similarly applied. The smartNIC 802 may be part of a host machine (not depicted) of a cloud computing environment on which hypervisor 804 executes. Hypervisor 804 may be configured to manage one or more virtual machines (e.g., VM 805) hosted by the host machine. Each VM may be a virtual machine, or bare metal instances can be similarly applied to the examples provided herein. One or more applications can run on operating system 806 of VM 805. By way of example, applications 807 may execute within operating system (OS) 806 at VM 805. Application 807 may be similar to application 220 and 605 of FIGS. 2 and 6, respectively. VM 805 and application 807 may be associated with a particular tenant/customer of a cloud computing environment. Application 807 may be configured to send and receive data to and from a corresponding block storage data plane (BSDP) component. For example, application 807 may be configured to transmit and receive data through processing pipeline 823 to a BSDP volume associated with a first namespace. In some embodiments, other applications running on operating system 806 may be configured to transmit and receive data through processing pipeline 823 (or another pipeline) to a BSDP volume associated with the same, or a different, namespace.

Namespace device 809 may be examples of namespace device 620 and namespace device 625 of FIG. 6 and can be associated with application 807. Although not depicted in FIG. 8, one or more additional namespace devices may be employed to route traffic intended for a particular BSDP component associated with that namespace. As a non-limiting example, NVMe/PCIe Controller 824 may route traffic to the namespace associated with namespace device 809 and application 807 through one or more corresponding namespace devices (not depicted), prior to such traffic being sent to NVMe Initiator 826. In other embodiments, any suitable portion of the functionality provided by one or more namespace devices may be encapsulated in and provided by NVMe initiator 826. In some embodiments, NVMe initiator 826 is an example of the NVMe/TCP initiators 750a and/750b of FIG. 7, NVMe/TCP initiator 325 of FIG. 3, NVMe Initiator 280 of FIG. 2, and/or initiator 162 of FIG. 1. In some embodiments, multiple namespaces may be utilized with multiple, or a single NVMe initiator 826.

A namespace may be associated with a non-volatile memory (NVM) storage that is formatted for block access. By way of example, a given namespace may be associated with a particular block storage volume of a block storage data plane of a cloud computing environment (e.g., the block storage data plane (BSDP) of FIG. 1 including extent servers fleet 140, one or more of which may be configured to provide a block storage volume/persistent storage within the BSDP). As discussed above, a namespace can be analogous to a logical unit in SCSI, and a block storage volume can be associated with a single namespace. Traffic may be routed along the path from application 807a, through namespace device 809, though NVMe/PCIe Controller 824, to NVMe initiator 826 and on to target servers associated with the same namespace (e.g., targets 814a-c, examples of the target fleet 145). Each of the targets 814a-c may serve as an endpoint that manages data receipt and/or transmissions that utilize network connections (e.g., NVMe/TCP connections, Remote Direct Memory Access (RDMA) connections, etc.) that are associated with the same namespace. In some embodiments, each of targets 814a-c are configured to receive data from a single and unique path for which the other endpoint corresponds to a unique IP address associated with the smartNIC. Data received from the applications 807 may be provided to the virtual function Input/Output queue (VFIO) 816 (e.g., the VFIO 635) in kernel 818 (an example of kernel 640 of FIG. 6). The virtual function (VF) 820 (an example of VF 645) may be connected to VFIO queue 816 via the VFIO peripheral component interconnect (PCI) 822 (an example of the VFIO PCI 650 of FIG. 6). VF 820 can be a virtual function or a physical function.

Processing pipeline 823 may include NVMe/PCIe controller 824, NVMe initiator 826, and paths 830a-c. In some embodiments, processing pipeline 823 may include one or more namespace devices (not depicted) corresponding to the namespace associated with namespace device 809. The NVMe/PCIe controller 824 (an example of NVMe P4 1575, NVMe/PCIe controller 655, etc.) may route traffic from the namespace devices 809 to those corresponding namespace devices, respectively. The NVMe namespaces can be associated with one or more paths (e.g., paths 830a-c, collectively referred to as “paths 830”). Each path 830a-c may correspond to one or more active or passive network paths (“active paths” or “passive paths,” for brevity). Each of the paths 830 may include a single active path (e.g., path 830a) and one or more passive paths (e.g., paths 830b and 830c, in this example, although any suitable number of passive paths may be utilized). Each of the paths 830 may be individually associated with a unique IP address assigned to the smartNIC. Each smartNIC IP address for a given path (e.g., path 830a) may differ from the smartNIC IP addresses used for the other paths (e.g., paths 830b-c) of paths 830.

The paths 830a-c may individually be associated with a namespace corresponding to a particular BSDP volume (e.g., BSDP persistent storage). In the ongoing examples, paths 830a-c are associated with a namespace with which targets 814a-c are also associated. Targets 814a-c may receive data via paths 830a-c intended for a particular BSDP volume/persistent storage. Targets 814a-c may transmit data from the BSDP volume/persistent storage along paths 830a-c to ultimately provide data to application 807.

In some embodiments, application 807 may be configured to transmit and receive data through one or more other processing pipelines different from processing pipeline 823 to a BSDP volume associated with a third namespace. Network traffic may be routed along the path from application 807 this additional processing pipeline (not depicted) and on to NVMe/TCP target servers associated with the same namespace (not depicted). This undepicted pipeline may include a similar number and mix of paths (e.g., one active and two passive paths). Data received from the application 807 may be provided to the virtual function Input/Output queue (VFIO) 816 (e.g., the VFIO 635) in kernel 818 (an example of kernel 640). The virtual function (VF) 820 (an example of VF 645) may be connected to VFIO queue 816 via the VFIO peripheral component interconnect (PCI) 822 (an example of the VFIO PCI 650). VF 820 can be a virtual function or a physical function.

Processing pipeline 832 may include NVMe/PCIe controller 826 and paths 840a-c. The NVMe/PCIe controller 826 (an example of NVMe P4 1575, NVMe/PCIe controller 655, etc.) may route traffic to a target server (e.g., target(s) 814a-c) via NVMe initiator 826. In some embodiments, NVMe/PCIe controller 826 may route traffic through a namespace device associated with the same namespace as a given target (e.g., target 814a) prior to the traffic reaching NVMe initiator 826.

The paths 840a-c may individually be associated with a namespace corresponding to a particular BSDP volume (e.g., BSDP persistent storage). As depicted, paths 840a-c are associated with a namespace with which targets 814a-c are also associated (e.g., corresponding to the namespace with which namespace device 809 is associated). Targets 814 may be configured, respectively, to receive data via paths 830 intended for a particular BSDP volume/persistent storage.

The number of paths corresponding to a particular BSDP volume/persistent storage may be identified based at least in part on a performance threshold associated with the BSDP volume/persistent storage. By way of example a particular BSDP volume may be associated with a performance threshold that indicates the BSDP volume can process up to 2 million input/output operations per second (IOPS). Each of the paths 830 may be associated with a performance capability indicating the maximum IOPS each path can sustain. In some embodiments, the performance capability of a path is the same for every path (e.g., 60,000 IOPS). In some embodiments, a block storage control plane (e.g., the block storage control plane 125 of FIG. 1) may be configured to identify a total number of active paths of a given performance capability (60,000 IOPS) needed to meet the performance threshold associated with the BSDP volume (2 million IOPS). The particular number of paths 830 depicted in FIG. 8 is not intended to limit the scope of this disclosure. A greater or fewer number of paths may be utilized.

SmartNIC 802 may include connection manager 828. Connection manager 828 may be an example of BSA 160, agent 310, BSA 515, etc. The connection manager 828 may be a software agent executed by the processor(s) of SmartNIC 802 (e.g., smartNIC CPU 520). The connection manager 828 may be configured to manage initiating paths 830 according to configuration information (e.g., the attachment metadata discussed in connection with FIG. 3) received from the block storage control plane (e.g., control plane 305). This configuration information may include any suitable data for establishing TCP connections (e.g., TCP connections 834a-c, each an example of the NVMe/TCP connections of FIG. 6) to various targets (e.g., target servers serving as endpoints for various corresponding block storage data plane volumes/persistent storages, such as targets 814). By way of example, the configuration information may specify, for each path, an IP address associated with the smartNIC 802 and an IP address corresponding to a target server (e.g., one of targets 814). In some embodiments, the configuration information may specify whether the TCP connection corresponding to each path is to be active (e.g., established and utilized) or passive (e.g., unestablished and not currently utilized). If passive, the configuration information with which a TCP connection may be established for that path may be stored, but the TCP connection may not be established until an indication is received from the connection manager 828 indicating that the path should be made active.

The connection manager 828 may be configured to communicate any suitable portion of the configuration information (e.g., configuration information corresponding to active paths only, configuration information for any active/passive path, etc.) to a NVM initiator 826 (e.g., initiator 162, NVMe initiator 280, etc., not depicted here) that may be configured to manage (e.g., store) that configuration information and/or establish or terminate corresponding TCP connections according to the configuration information. NVMe Agent 530 and/or VPP/DPDK 545 may operate as part of the NVMe initiator 826. The NVMe initiator 826 may employ the process by which TCP connections are established as discussed in connection with FIG. 5 to establish the TCP connections between paths 830 and corresponding targets (e.g., targets 814). NVMe/TCP initiator 826 may utilize NVMe Agent 530 and/or VPP/DPDK 545 to terminate NVMe/TCP connections as instructed by connection manager 828.

Conventionally, connections could fail due to network issues or target restarts among other reasons. The connection manager 828 may be configured to detect these failures and select another path to activate (e.g., to assign as the new active path). Determining whether to or to which path to failover to did not factor in the CPU utilization of targets 814. Ongoing high CPU utilization can lead to processing delay, slowdown, failure, and component damage. Therefore, it was possible to failover to a suboptimal path which may cause unintended and disadvantageous consequences. The term “heat measurement” may be used herein to refer to a CPU utilization value or any suitable CPU-related data. In any example provided herein, a “heat measurement” may include any suitable combination of inputs including, but not limited to, CPU utilization, network utilization, network latency, and memory utilization. “Heat” or a “heat score” are used to refer to a logical function used to normalize CPU utilization values (and/or network utilization, network latency, memory utilization, etc.) in light of current network traffic. “Heat measurements” are intended to refer to any suitable combination of CPU utilization values, network utilization values, network latency values, and/or memory utilization values currently being utilized and/or experienced at one or more target servers.

To remedy these issues, connection manager 828 may be configured to obtain and consider heat measurements (e.g., CPU utilization values) corresponding to respective storage components (e.g., targets 814) when determine whether to initiate a failover and/or to select a particular target to which to failover. In some embodiments, the connection manager 828 may be configured to request information associated with the network traffic or the network traffic itself from the any suitable combination of NVMe/PCIe Controllers 824, NVMe initiator 826, and/or any suitable namespace device described in connection with FIG. 8.

Connection manager 828 may be configured to identify input/output operations of the network traffic data (e.g., data indicating the network traffic is associated with an I/O operation, the data payload of the network traffic, the network traffic itself) obtained. The number of input/output operations corresponding to a given namespace or path group (e.g., path group 832 comprising paths 830a-c) may be identified over a period of time. In some embodiments, the connection manager 860 may identify a data payload size corresponding to the network traffic from the network traffic data obtained and may calculate a throughput value for the path(s) corresponding to a given BSDP volume/persistent storage and/or namespace. At any suitable time, connection manager 828 may request heat measurement data (e.g., CPU utilization values or any suitable CPU related data) from each of targets 814 or from a subset of targets 814. By way of example, in a failover event in which the connection 834a has failed, connection manager 828 may request heat measurement data from targets 814b and 814c (e.g., the passive paths corresponding to path 830a, the currently active path which has failed). In some embodiments, heat measurement data may include a measurement of CPU utilization of the target (e.g., the CPU processing currently utilized by its dedicated CPU core). In some embodiments, this measurement may be expressed as a percentage (e.g., 80% CPU utilization). Heat measurement data may be requested at any suitable time, periodically, or according to a predefined schedule implemented by the connection manager 828.

In some embodiments, a heat score (e.g., a normalized CPU utilization value), HS, may be calculated by the connection manager 828 for each target of a passive path (e.g., targets 814b and 814c in the ongoing example) by dividing the I/O operations rate (e.g., I/O operations per second (IOPS)) of the path group (PG) by the heat measurement of the target, heat(T) (e.g., the CPU utilization expressed as a percentage or a value between 0 and 1), subtracted from 1. This calculation can be expressed by the formula:

$$HS = \frac{IOPS ( PG )}{1 - heat ( T )}$$

The larger the heat score is, the higher the chance that the corresponding target might underperform within the path group PG. Therefore, the connection manager 828 may be configured to select a passive path that has the lowest heat score for failover. This ensures the lowest risk of IO processing delay, subsequent failover, and negative impact to the customer and system. By reducing the risk of failovers, the processing resources of the smartNIC and system as a whole is improved.

In some embodiments, heat measurements (e.g., CPU utilization values) may be used to modify the active path even when the active path has not failed. By way of example, connection manager 828 may be configured to enforce a predefined threshold. Periodically, the connection manager 828 may request network traffic data (e.g., IOPS) from the NVMe initiator 826 as well as heat measurements from targets 814a-c. Once obtained, connection manager 828 may calculate a heat score for each target. In some embodiments, if the heat score of the target of the currently active path (e.g., target 814a, corresponding to path 830a) breaches the predefined threshold value, the connection manager 828 may be configured to automatically select a passive path (e.g., a passive path having a lowest heat score). As a non-limiting example, should the heat score corresponding to path 830a breach this threshold value, the connection manager 828 may execute instructions to cause NVMe initiator 826 to establish connection 834b corresponding to path 830b when the heat score corresponding to path 830b is deemed to be lower than those heat scores corresponding to paths 830a and 830c. In some embodiments, even if the heat score corresponding to path 830a breaches the predefined threshold, a new path may not be selected unless the path 830a has a lower heat score than that of path 830a. In some embodiments, a new path may not be selected unless its heat score is less than the heat score of the currently active path by at least a threshold amount. This may reduce instances in which connection manager 828 might otherwise cause a new connection to be established and assigned as the active path that does not significantly improve the latency risk or otherwise provide a substantial benefit. By ensuring the selected path is substantially better (e.g., having a heat score that is less than the heat score of the currently active path by at least a threshold amount), the connection manager 828 may ensure that processing resources are not wastefully applied to bring about a scenario that may not be significantly better than the one being experienced to begin with.

This process may be performed on an ongoing basis enabling the connection manager 828 to dynamically adjust the active/passive paths. These techniques provide improvements over conventional methods by enabling connection decisions to account for high CPU usage utilized by the target. Overall, these techniques provide an intelligent selection scheme that minimizes wasteful connection processing while reducing the risk of delays and failures computing components which would negatively impact the system, customer, and cloud provider alike.

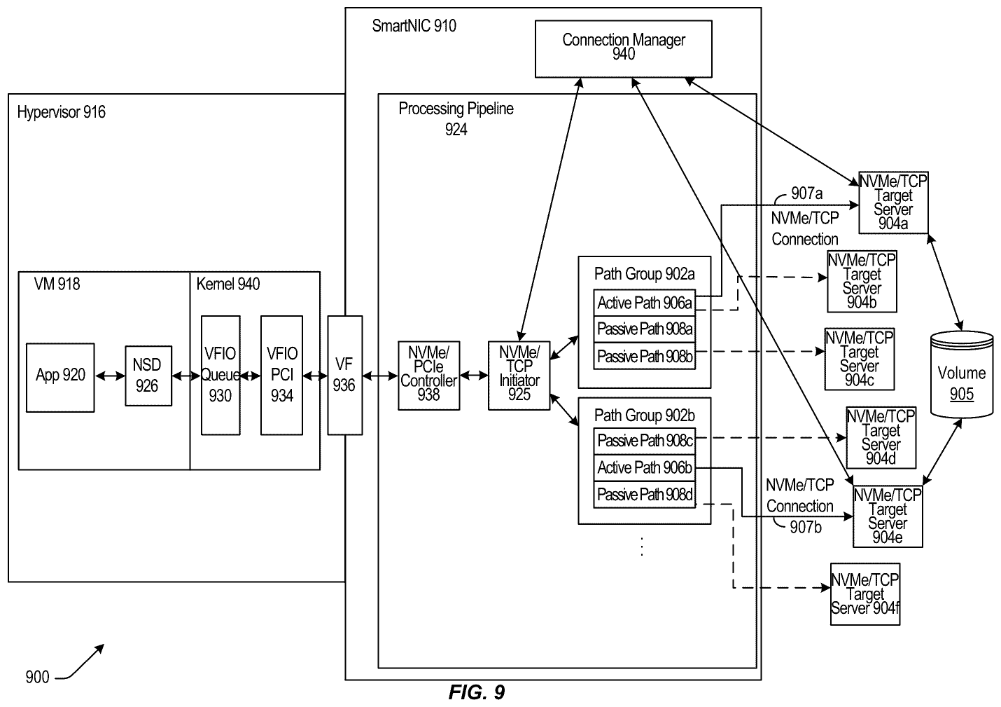

FIG. 9 is a diagram 900 of yet another example showing network connection management in a smart network interface card (smartNIC), according to an embodiment. The example of FIG. 9 is intended to depict a use case in which a number of path groups are utilized. Each path group (e.g., path group 902a and path group 902b) may include any suitable number of active and passive paths. An active path (e.g., active paths 906a and 906b) may correspond to a TCP connection to an NVMe/TCP target server of NVMe/TCP target servers 904a-f, each an example of the targets 814 of FIG. 8, NVMe/TCP target servers 630a-i of FIG. 6, etc. Each of NVME/TCP target servers 904a-f may serve as an endpoint for volume 905 (e.g., a block storage volume). Connection manager 940 (an example of connection manager 828 of FIG. 8) may store configuration information for the paths of path groups 902a and 902b). Connection manager 940 may be configured to transmit instructions to NVMe/TCP initiator 925 to establish or terminate NVMe/TCP connections (e.g., NVMe/TCP connection 907a) at any suitable time based at least in part on predefined criteria and/or conditions.

The components of FIG. 9 may generally correspond to the components described in connection with FIG. 8. For example, Hypervisor 916 may be an example of Hypervisor 804 and may be configured to manage one or more virtual machines (e.g., VM 918, an example of VM 805) hosted by the host machine. VM 918 may be a virtual machine, or bare metal instance. Application 920 (e.g., an example of the application 805) may run at VM 918. Application 920 may execute within operating system (OS) 922 (an example of the OS 815). VM 918 may be associated with a particular tenant/customer of a cloud computing environment. Application 920 may be configured to send and receive data to and from a corresponding block storage data plane (BSDP) component (e.g., volume 905). For example, application 920 may be configured to transmit and receive data through processing pipeline 924 to volume 905 associated with a first namespace. Each component through which the network traffic passes may likewise be associated with the same namespace.

Namespace device 926, an example of the namespace devices 809 of FIG. 8, can be associated with application 920. The namespace may be associated with a particular block storage volume (e.g., volume 905) of a block storage data plane of a cloud computing environment (e.g., an example of the block storage data plane (BSDP) of FIG. 1 including extent servers fleet 140, one or more of which may be configured to provide a block storage volume/persistent storage within the BSDP). Network traffic may be routed along the path from application 920, through namespace device 926, to NVMe PCIe controller 938 and/or NVMe/TCP initiator 925 and on to NVMe/TCP target servers associated with the same namespace (e.g., the NVMe/TCP target servers 914a-f). Any suitable combination of the targets 914a-f may serve as an endpoint that manages data receipt and/or transmissions that utilize TCP connections that are associated with the same namespace. By way of example, NVMe/TCP target servers 904a-f may be associated with the same namespace as the path groups 902a and b and the active/passive paths of each of those path groups. In some embodiments, each of NVMe/TCP target servers 904a-f are configured to receive data from a single and unique path for which the other endpoint corresponds to a unique IP address associated with the smartNIC. By way of example, NVMe/TCP target servers 904a may be configured to receive transmit data through a TCP connection with the smartNIC 910 (e.g., NVMe/TCP connection 907a) that corresponds the IP address associated with active path 906a. Similarly, NVMe/TCP target server 904e may be configured to receive/transmit data from/to the smartNIC 910 using a TCP connection corresponding to active path 906b (e.g., NVMe/TCP connection 907b). Data received from the application 920 may be provided to the virtual function Input/Output (VFIO) queue 930 (e.g., the VFIO Queue 816, VFIO Queue 635) in kernel 818 (an example of kernel 640). The virtual function (VF) 936 (an example of VF 820, VF 645) may be connected to VFIO queue 930 via the VFIO peripheral component interconnect (PCI) 934 (an example of the VFIO PCI 822, VFIO PCI 650). VF 936 can be a virtual function or a physical function.

Processing pipeline 924 may include NVMe/PCIe controller 938, NVMe/TCP initiator 925 (e.g., initiator 162 of FIG. 1, NVMe initiator 280 of FIG. 2, etc.), and path groups 902a and 902b that individually include respective sets of active/passive paths 906/908, as depicted. The NVMe/PCIe controller 938 (an example of NVMe/PCIe controller 824, NVMe P4 1575, NVMe/PCIe controller 655, etc.) may route traffic from the namespace device 926 to path groups 902. In some embodiments, one or more additional namespace devices (not depicted) may be utilized within processing pipeline 924. By way of example, network traffic can be routed via NVMe namespace 926 through NVMe/PCIe controller 938 and an additional namespace device (not depicted) before being forwarded to NVMe/TCP initiator 925 and along to NVMe/TCP connection corresponding to one of active paths 906a or 906b, to be ultimately received by one of NVMe/TCP target servers 904a or 904e depending on the active path and corresponding NVMe/TCP connection utilized.

SmartNIC 910 may include connection manager 940. Connection manager 940 may be an example of connection manager 860 of FIG. 8, BSA 160 of FIG. 1, agent 310 of FIG. 3, BSA 515 of FIG. 5, etc. The connection manager 940 may be a software agent executed by the processor(s) of SmartNIC 802 (e.g., smartNIC CPU 520). The connection manager 940 may be configured to manage paths 906 and 908 (e.g., network paths) according to the path groups 902 to which those paths are associated (e.g., according to configuration information (e.g., attachment metadata of FIG. 3) received from the block storage control plane (e.g., control plane 305), not depicted here). The configuration information may specify, for each path, an IP address associated with the smartNIC 802 and an IP address corresponding to a target server (e.g., one of NVMe/TCP target servers 904). In some embodiments, the configuration information may specify whether the TCP connection corresponding to each path is to be active (corresponding to active paths 906a and 906b) or passive (e.g., corresponding to passive paths 908a-d). If passive, the configuration information with which a TCP connection may be established for that path may be stored, but the TCP connection may not be established or utilized until an indication is received from the connection manager 940 indicating that the path should be made active.

The connection manager 940 may be configured to communicate any suitable portion of the configuration information (e.g., configuration information corresponding to active paths only, configuration information for any active/passive path, etc.) to a NVMe/TCP initiator 925 (e.g., initiator 162, NVMe initiator 280, etc.) that may be configured to manage (e.g., store) that configuration information and/or establish and/or terminate corresponding TCP connections according to the configuration information. NVMe Agent 530 and/or VPP/DPDK 545, each described above in connection with FIG. 5, may operate as part of the NVMe/TCP initiator 925. The functionality provided by NVMe Agent 530 and/or VPP/DPDK 545 may be provided by the NVMe/TCP initiator 925 and the process by which NVMe/TCP connections are established as discussed in connection with FIG. 5 may be similarly employed to establish the TCP connections between paths 830 and 840 and corresponding targets. NVMe/TCP initiator 925 may utilize NVMe Agent 530 and/or VPP/DPDK 545 to terminate NVMe/TCP connections as instructed by connection manager 940.

In some embodiments, the TCP connection of an active path one that is already established or is soon to be established based on its association to (or assignment as) an active path. Each path group may include any suitable number of passive paths (e.g., passive paths 908a-d). A passive path may be associated with configuration information with which a TCP connection may be later established. However, TCP connections may not be established for paths while they are designated as being passive. Each passive path and the corresponding configuration information may be utilized during a failover procedure when it is determined that the TCP connection associated with a corresponding active path is compromised (e.g., a threshold number of network packets have been dropped, a heat score (e.g., a CPU utilization value that is normalized for network traffic conditions) associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.). In this manner, network traffic may be balanced across path groups (e.g., path groups associated with the same namespace).

At any suitable time (e.g., periodically, according to a predefined schedule, etc.), connection manager 940 may obtain network traffic data from NVMe/TCP initiator 925. The network traffic data may include any suitable metadata corresponding to the network traffic traveling through the NVMe initiator 925 and on to any suitable path of path groups 902a and/or 902b. In some embodiments, NVMe initiator 925 may be configured to provide first network traffic data corresponding to path group 902a and second network traffic data corresponding to path group 902b. In some embodiments, NVMe initiator 925 may provide network traffic data that includes combined details of the network traffic for both path groups 902a and 902b and the connection manager 940 may be configured to differentiate network traffic data corresponding to path group 902a from that of path group 902b.

At any suitable time (e.g., periodically, according to a predefined schedule, etc.), connection manager 940 may obtain heat measurements (e.g., CPU utilization values) from any suitable combination of NVMe/TCP target servers 904. In some embodiments, connection manager 940 may request/obtain heat measurements from NVMe/TCP target servers that correspond to the active paths (e.g., active path 906a and active path 906b). Connection manager 940 may request and/or obtain heat measurements from NVMe/TCP target servers that correspond to passive paths only when the active paths are determined to be compromised (e.g., a threshold number of network packets have been dropped, a heat score (e.g., a normalized CPU utilization value) associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.). In some embodiments, connection manager 940 may obtain heat measurements from all NVMe/TCP target servers according to a predefined periodicity or schedule, regardless of whether the active paths have been determined to be compromised. In some embodiments, heat measurements may be requested from the NVMe/TCP target server (e.g., via an agent executing at the NVMe/TCP target server) and may be in any suitable form to indicate CPU utilization of the corresponding NVMe/TCP target server.

In some embodiments, a heat score (e.g., a normalized CPU utilization value), HS, may be calculated by the connection manager 940 for each path/connection/target for which corresponding network traffic data and heat measurements (e.g., CPU utilization values) have been obtained. A heat score for each path/connection/target may be calculated by dividing the I/O operations rate (e.g., I/O operations per second (IOPS)) of the path group (PG), obtained from the network traffic data, by the heat measurement of the target, heat(T), subtracted from 1. This calculation can be expressed by the formula:

$$HS = \frac{IOPS ( PG )}{1 - heat ( T )}$$

The larger the heat score is, the higher the chance that the corresponding target might underperform within the path group PG. Therefore, the connection manager 940 may be configured to select a different path that has a lower heat score than the heat score associated with the currently active path. This ensures the lowest risk of processing delays, subsequent failover, and negative impacts to the customer and system. By reducing the risk of performance degradation, the processing resources of the smartNIC and system as a whole is improved.

As an example, a TCP connection (e.g., NVMe/TCP connection 907a) corresponding to active path 906a may be established (e.g., by NVMe/TCP initiator 925 via instructions from connection manager 940) and maintained between an IP address of the smartNIC 910 (e.g., the smartNIC 802) and NVMe/TCP target server 904a. While the NVMe/TCP connection corresponding to active path 906a is operational/established, the configuration information for establishing TCP connections corresponding to passive paths 908a and 908b (e.g., the passive paths associated with the same path group, here, path group 902a) may be stored but unestablished and unutilized. While the NVMe/TCP connection 907a that is associated with the active path 906a is utilized and uncompromised, no TCP connections may be established for the passive paths 908a and 908b.

The connection manager 940 may monitor the network traffic data (e.g., obtained from NVMe/TCP initiator 925 either by request or through periodic transmission by NVMe/TCP initiator 925). Connection manager 940 may request or otherwise obtain (e.g., through periodic transmission from NVMe/TCP target servers 904) heat measurements (e.g., CPU utilization values) for at least NVMe/TCP target server 904a. Although in some examples, the connection manager 940 may obtain heat measurement data from any suitable combination of NVMe/TCP target servers 904, including target servers corresponding to currently passive paths.

At any suitable time, if connection manager 940 determines that the active path 906a is determined to be compromised (e.g., a threshold number of network packets have been dropped, a heat score calculated from the network path data and heat measurements associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.), one of the passive paths (e.g., passive path 908a) may be activated to take become the active path. The TCP connection 907a for active path 906a, if still established, may be terminated and the configuration information corresponding to that TCP connection may be maintained at the smartNIC 910. The active path 906a may be designated as being a passive path and the passive path (e.g., passive path 908a), now having an established NVMe/TCP connection to NVMe/TCP target server 904b, a target server associated with the same BSDP volume (e.g., volume 905) and/or namespace as NVMe/TCP target server 904a, may be designated/associated with an indicator indicating the passive path 908a is now the active path (e.g., for path group 902a).

It should be appreciated that, in some embodiments, failure of the active path 906a need not occur for a passive path to be activated. For example, connection manager 940 may calculate heat scores for each path of a path group (e.g., path group 902a). In some embodiments, if a heat score of a passive path is substantially lower (e.g., lower by at least a threshold amount), the passive path may be activated, a connection may be established, and the passive path (e.g., passive path 908b, determined to have a heat score that is lower than that of active path 906a by at least a threshold amount) may be designated as the new active path. In this scenario, connection 907a may be terminated and active path 906a may be newly designated as a passive path. In some embodiments, passive path 908b may be selected based at least in part on having a heat score that is lower than the heat score of active path 906a by at least a threshold amount and, in some scenarios, also lower than the heat score corresponding to passive path 908a.

Each path group and the corresponding active/passive paths may be associated with a common namespace. Multiple path groups may correspond to a common namespace. For example, path groups 902a and 902b may correspond to the same namespace and each may include a combination of active and passive paths, each of which may also be associated with the same namespace. In some embodiments, similar techniques as discussed above may be employed to balance network traffic across path groups. By way of example, should the active path 906a be compromised, the active path 906b may be selected and utilized for network traffic corresponding to the namespace. In some embodiments, selecting active path 906b may be based at least in part on the active path 906b having a lower heat score than active path 906a (e.g., by at least a threshold amount), a lowest heat score of all of the paths of path groups 902a and 902b, A number of predefined selection rules may be utilized that ensure that network traffic is optimally spread across path groups and/or to a single path group depending on the current network traffic throughput of each path group and the heat measurements corresponding to the NVMe/TCP target servers 904a-f. The active path 906b may be associated with an active connection (e.g., NVMe/TCP 907b) prior to being selected for network traffic that would have previously been sent through one of the paths of path group 902a.

In some embodiments, connection manager 940 may be configured to add or remove path groups depending on heat scores. By way of example, a heat score for active path 906a may breach a predefined threshold. In this scenario, the heat scores calculated for passive paths 908a and 908b may not be significantly lower, or in other words, the heat scores of passive paths 908a and 908b may not be lower than a predefined threshold value from the heat score of active path 906a. In this scenario, the connection manager 940 may be configured to generate a new path group (e.g., path group 902b). In some embodiments, the new path group may be generated based on any suitable configuration information stored by connection manager 940. An active path for path group 902b may be selected based on heat scores and/or due to an indicator or designation of the path as being the active path of path group 902b. In some embodiments, the number of paths and/or path groups may be modified based at least in part on network traffic rates (e.g., IOPS), where active paths are selected based on heat scores.

The functionality and operations discussed above with respect to network traffic monitoring and the modifications made to the TCP connections and active/passive paths and/or path groups may be provided by the connection manager 940 on an ongoing basis.

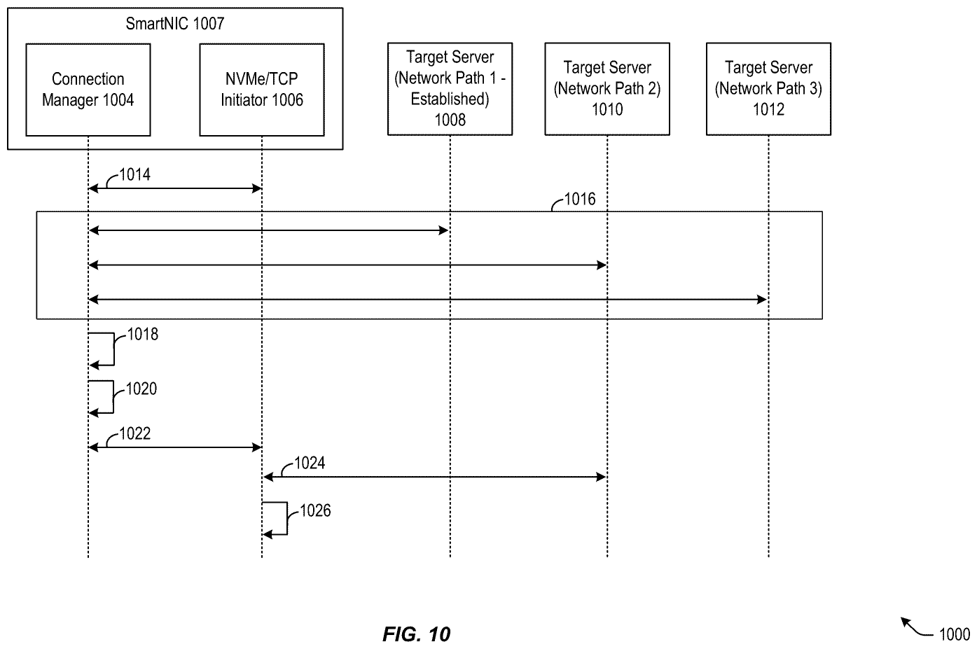

FIG. 10 is a diagram illustrating a process 1000 for managing network (e.g., NVMe over TCP, NVMe over RDMA, etc.) connections utilized between a smartNIC and a storage data plane of a cloud computing environment (e.g., the TCP connections discussed in connection with FIG. 8, the NVMe/TCP connections discussed in connection with FIGS. 6 and 9, etc.), according to an embodiment. As part of process 1000 configuration information may be generated by block storage control plane 1002 (e.g., block storage control plane 125 of FIG. 1, control plane 305 of FIG. 3, etc.). The configuration information may specify, for each path, an IP address associated with the smartNIC 802 and an IP address corresponding to a target server (e.g., one of NVMe/TCP target servers 904). In some embodiments, the configuration information may specify whether the TCP connection corresponding to each path is to be active (corresponding to active paths 906a and 906b of FIG. 9) or passive (e.g., corresponding to passive paths 908a-d of FIG. 9).

The number of paths corresponding to a particular BSDP volume/persistent storage may be identified by block storage control plane (BSCP) (not depicted) based at least in part on a performance threshold associated with a given BSDP volume/persistent storage. The BSCP may provide the configuration information to connection manager 1004 (e.g., connection manager 940 of FIG. 9, connection manager 860 of FIG. 8, BSA 160 of FIG. 1, BSA 515 of FIG. 5, etc.) The connection manager 1004 may be configured to communicate any suitable portion of the configuration information (e.g., configuration information corresponding to active paths only, configuration information for any active/passive path, etc.) to a NVMe/TCP initiator 1006 (e.g., NVMe/TCP initiator 925 of FIG. 9, initiator 162 of FIG. 1, NVMe initiator 280 of FIG. 2, etc.) that may be configured to manage (e.g., store) that configuration information and/or establish and/or terminate corresponding TCP connections according to the configuration information. In some embodiments, the connection manager 1004 may forward only information corresponding to active paths identified in the configuration information to the NVMe/TCP initiator 1006 while storing the configuration information corresponding to passive paths in memory for subsequent use.

As a non-limiting example prior to execution of method 1000, a connection (e.g., corresponding to network path 1, an active path) may be established between the smartNIC 1007 (e.g., smartNIC 910 of FIG. 9) and target server 1008 (e.g., NVMe/TCP Target Server 904a of FIG. 9). The connection manager 1004 may forward any suitable portion of the connection information or corresponding instructions to cause NVMe/TCP initiator 1006 to activate and/or establish an active path (e.g., an active path to target server 1008). The NVMe/TCP initiator 1006 may include any suitable combination of the NVMe agent 530 and VPP/DPDK module 545 of FIG. 1 and can establish a new I/O connection in response to a request from connection manager 1004 in the manner described above in connection with FIG. 5. In some embodiments, NVMe/TCP connections may not be established for any the passive paths (e.g., paths corresponding to target server 1010 and target server 1012) until and unless the connection manager 1004 instructs the NVMe/TCP initiator 1006 to establish, using passive path data, a new NVMe/TCP connection. Once established, the NVMe/TCP initiator 1006 and/or the connection manager 1006 may update the configuration information stored at the smartNIC 1006 to indicate the newly established NVMe/TCP connection to target server 1008 is associated with the currently active path. This may include updating an indicator of the configuration information corresponding to that path to a value that indicates an active path. The selection of the target server 1008 and/or managing the paths (active versus passive) between target servers 1008, 1010, and 1012 may be performed by executing the process 1000.

At 1014 of process 1000, the connection manager 1004 may obtain and/or request network traffic data from NVMe/TCP initiator 1006. In some embodiments, the connection manager 1004 may request the network traffic data according to a predefined periodicity and/or schedule. In some embodiments, the NVMe/TCP initiator 1006 may transmit the network traffic data according to a predefined periodicity and/or schedule. In some embodiments, the network traffic data may include any suitable attributes corresponding to the network traffic passing through the NVMe/TCP initiator 1006. In some embodiments, the network traffic data may include a rate of network traffic, or a rate of the network traffic may be calculated by the connection manager 1004. As a non-limiting example, the connection manager 1004 may identify, from the network traffic data, a number of Input/Output operations of the network traffic data and may determine/calculate the rate of those I/O operations over a period of time (e.g., per second, per minutes, or the like). By way of example, the number of IOPS, corresponding to I/O operations processed per second, may be calculated by the connection manager 1004.

At 1016, the connection manager 1004 may obtain and/or request heat measurements (e.g., CPU utilization values/CPU-related data) from any suitable combination of the target servers 1008, 1010, and/or 1012. In some embodiments, the connection manager 1004 may request/obtain the heat measurements according to a predefined periodicity and/or schedule. In some embodiments, the target servers 1008, 1010, and/or 1012 may transmit their heat measurements according to a predefined periodicity and/or schedule. It may be the case that the connection manager 1004 may obtain/request heat measurements from target server 1008 (corresponding to the active path) unless a condition is triggered, or a criterion is met. For example, the connection manager 1004 may monitor only an active paths heat measurements unless the active path is determined to be compromised (e.g., a threshold number of network packets have been dropped, a heat score (e.g., a current CPU utilization that is normalized with respect to current network traffic) associated with the active path exceeds a predefined threshold value, a last time a network packet was transmitted or received by the smartNIC 1007 or NVMe/TCP target server 1008 has exceeded a predetermined threshold period of time, the NVMe/TCP connection to target server 1008 has been lost, etc.). In other embodiments, heat measurements may be obtained from target servers 1008, 1010, and 1012, regardless of whether the active path to target server 1008 is deemed to be compromised.

At 1018, the connection manager 1004 may calculate heat scores in the manner discussed above in connection with FIGS. 8 and 9 for any suitable combination of the target servers 1008-1012 for which network traffic data and heat measurements are known.

At 1020, the connection manager 1004 may determine that the active path should be modified. As discussed above, this may be due to a number of conditions/criteria. For example, the connection manager 1004 may determine that the connection to target server 1008 has been compromised (e.g., a threshold number of network packets have been dropped, a heat score associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.). In any case, the connection manager 1004 may identify (e.g., from the heat scores of target server 1010 and 1012) a target server having a lowest heat score. The target server (e.g., target server 1010 corresponding to network path 2) selected may be assigned as the new active path.

At 1022, the connection manager 1004 may instruct the NVMe/TCP initiator 1006 to assign network path 2 corresponding to target server 1010) as the new active path.

At 1024, the connection manager 1004 may establish a connection between smartNIC 1007 and target server 1010 and mark/associate the connection as the active path.

At 1026, the connection manager 1004 may terminate the connection between smartNIC 1007 and target server 1008 and may mark/associate the network path to target server 1008 as passive.

Process 1000 may be performed any suitable number of times as part of ongoing monitoring of connections by the connection manager 1004. It should be appreciated that the operations of process 1000 may be performed in any suitable order. More or fewer operations may be performed different from the ones depicted in FIG. 10.

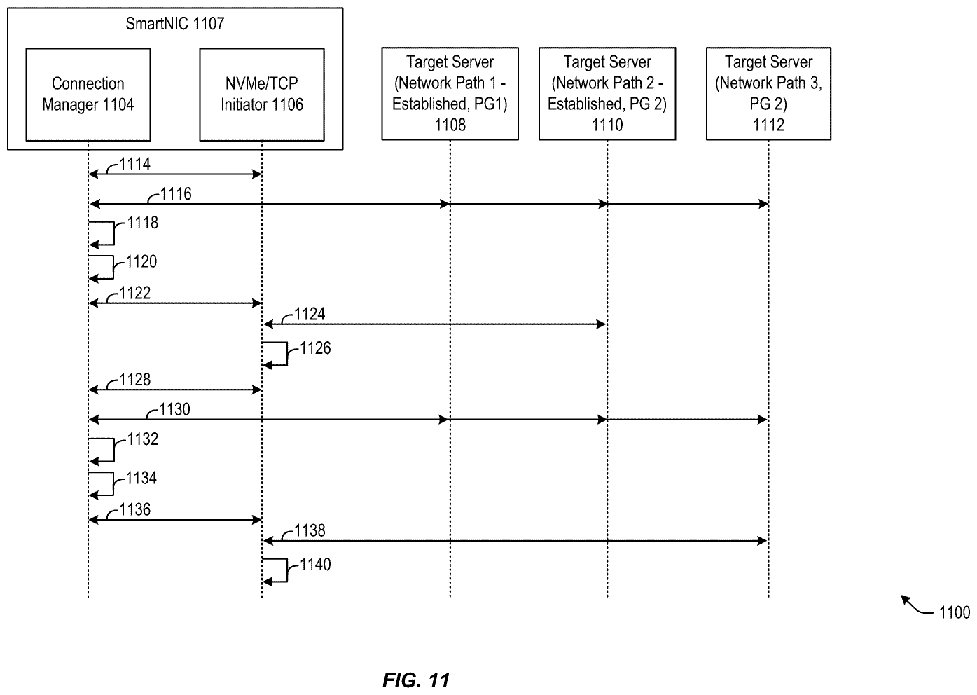

FIG. 11 is a flow diagram illustrating another example process 1100 for managing network connections (e.g., NVMeOTCP connections, NVMe over RDMA connections, etc.) utilized between a smartNIC and a data plane resource of a cloud computing environment (e.g., the TCP connections discussed in connection with FIG. 8, the NVMe/TCP connections discussed in connection with FIGS. 6 and 9, etc.), according to an embodiment. As discussed above in connection with FIG. 10, as part of process 1100 or prior to the execution of process 1100, configuration information may be generated by a block storage control plane (e.g., block storage control plane 125 of FIG. 1, control plane 305 of FIG. 3, etc.) and used to establish a connection between smartNIC 1107 and target server 1108. In the example depicted in FIG. 11, target server 1108 may be part of one path group (referred to as “PG1,” corresponding to path group 902a, while target servers 1110 and 1112 may be part of another path group (referred to as “PG2,” corresponding to path group 902b). In some embodiments, a connection may already be established with target server 1110 (e.g., an active path of the path group PG2, or a connection to target server 1110 may not yet be established.

At 1114 of process 1100, the connection manager 1104 may obtain and/or request network traffic data from NVMe/TCP initiator 1106. In some embodiments, the connection manager 1104 may request the network traffic data (e.g., network traffic going through going through PG1 and PG2) according to a predefined periodicity and/or schedule. In some embodiments, the NVMe/TCP initiator 1106 may transmit the network traffic data according to a predefined periodicity and/or schedule. In some embodiments, the network traffic data may include any suitable attributes corresponding to the network traffic passing through the NVMe/TCP initiator 1106 (e.g., network traffic corresponding to PG1 and/or PG2). In some embodiments, the network traffic data may include a rate of network traffic, or a rate of the network traffic may be calculated by the connection manager 1104. As a non-limiting example, the connection manager 1104 may identify, from the network traffic data, a number of Input/Output operations of the network traffic data and may determine/calculate the rate of those I/O operations over a period of time (e.g., per second, per minutes, or the like). By way of example, the number of IOPS, corresponding to I/O operations processed per second, may be calculated by the connection manager 1104.

At 1116, the connection manager 1104 may obtain and/or request heat measurements (e.g., current CPU utilization values and/or CPU-related data) from any suitable combination of the target servers 1108, 1110, and/or 1112. In some embodiments, the connection manager 1104 may request/obtain the heat measurements according to a predefined periodicity and/or schedule. In some embodiments, the target servers 1108, 1110, and/or 1112 may transmit their heat measurements (e.g., CPU utilization values and/or other suitable CPU-related data) according to a predefined periodicity and/or schedule. It may be the case that the connection manager 1104 may obtain/request heat measurements from target server 1108 (corresponding to the active path of PG1) unless a condition is triggered, or a criterion is met. For example, the connection manager 1104 may monitor only an active paths heat measurements unless the active path is determined to be compromised (e.g., a threshold number of network packets have been dropped, a heat score associated with the active path exceeds a predefined threshold value, a last time a network packet was transmitted or received by the smartNIC 1107 or NVMe/TCP target server 1108 has exceeded a predetermined threshold period of time, the NVMe/TCP connection to target server 1108 has been lost, etc.). In other embodiments, heat measurements may be obtained from target servers 1108, 1110, and 1112, regardless of whether the active path to target server 1108 is deemed to be compromised. In some embodiments, the connection to target server 1110 of PG2 may be an active path with an established connection, while target server 1112 may corresponding to a passive path of PG2 for which a connection has not get been established.

At 1118, the connection manager 1104 may calculate heat scores (e.g., a CPU utilization values that are normalized with respect to current network traffic conditions) in the manner discussed herein for any suitable combination of the target servers 1108-1112 for which network traffic data and heat measurements are known. In some embodiments, only heat measurements from active paths (e.g., paths to target servers 1108 and 1110) may be obtained and used to calculate heat scores at 1118. In other embodiments, heat measurements from a larger number of target servers (e.g., target servers corresponding to passive paths such as target server 1112) may be obtained and corresponding heat scores may be calculated.

At 1120, the connection manager 1104 may determine that the active path should be modified or the network traffic for the namespace should be balanced/distributed across active paths of multiple path groups. A replacement may be identified due to a number of conditions/criteria. For example, the connection manager 1104 may determine that the connection to target server 1108 has been compromised (e.g., a threshold number of network packets have been dropped, a heat score associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.). As another example, the network traffic may be distributed across active paths 1108 and 1110 depending on their respective heat scores.

In a replacement scenario, the connection manager 1104 may identify (e.g., from the heat scores of target server 1110 and/or 1112) a target server having a lowest heat score. In some cases, only heat scores of other active paths of path groups that are associated with the same namespace may be considered. In scenarios in which there are more than two path groups available, the network traffic data and heat measurements of these additional path groups may be utilized to select an optimal path (e.g., an active path or, in some cases, passive path having a lowest heat score). As an example, a target server (e.g., target server 1110 corresponding to network path 2) may be selected due to having a lowest heat score and may be assigned as the new active path.

At 1122, in replacement scenarios, the connection manager 1104 may instruct the NVMe/TCP initiator 1106 to assign network path 2 corresponding to target server 1110 as the new active path. Alternatively, in cases in which network traffic is to be distributed across path groups, the NVME/TCP initiator 1106 may assign a first amount of the network traffic to target server 1108 and a second amount of the network traffic to target server 1110. The values for the first amount and the second amount may be based at least in part on the respective heat scores of target server 1108 and 1110. In some embodiments, a higher amount of the network traffic may be directed to target server 1108 or target server 1110 depending on which target server has the lower heat score. In some embodiments, the amounts may be proportional. That is, if target server 1108 has a heat score that is 60% of the combined heat score of target servers 1108 and 1110, then 40% of the network traffic may be provided to the target server 1108. Likewise, if target server 1110 has 40% of the combined heat score, then 60% of the network traffic may be directed to target server 1110. In this manner, network traffic may be balanced/distributed across path groups according to each active path's respective heat score.

At 1124, if a connection has not yet been established between smartNIC 1107 and target server 1110 the connection manager 1104 may establish a connection between smartNIC 1107 and target server 1110 and mark/associate the connection as an active path.

At 1126, in replacement scenarios, the connection manager 1104 may terminate the connection between smartNIC 1107 and target server 1108.

The operations performed at 1128-1132 may generally correspond to the operations performed at 1114-1118.

At 1134, the connection manager 1104 may determine that the active path should be modified or network traffic is to be distributed/redistributed over multiple path groups due to determining that the connection to target server 1108 has been compromised (e.g., a threshold number of network packets have been dropped, a heat score associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.).

In some embodiments, the connection manager 1104 may identify (e.g., from the heat scores of target server 1110 and/or 1112 and/or any other target server of PG2 (not depicted)) a target server having a lowest heat score. As before, in scenarios in which there are more than two path groups available, the network traffic data and heat measurements of these additional path groups may be utilized to select an optimal path (e.g., an active or passive path having a lowest heat score). As an example, a target server (e.g., target server 1112 corresponding to network path 3) may be selected due to having a lowest heat score and may be assigned as the new active path.

At 1136, the connection manager 1104 may instruct the NVMe/TCP initiator 1106 to assign network path 3 corresponding to target server 1112 as the new active path.

At 1138, the connection manager 1104 may establish a connection between smartNIC 1107 and target server 1112 and mark/associate the connection as the active path.

At 1140, the connection manager 1104 may terminate the connection between smartNIC 1107 and target server 1110 and may mark/associate the network path to target server 1110 as passive.

Although not depicted, the connection manager 1104 may be configured to monitor the heat scores of target servers 1108 and 1112 over time. As these heat scores fluctuate, the connection manager 1104 may modify (e.g., add or subtract) active paths utilized for network traffic of the same namespace and/or may redistribute the network traffic across path groups depending on each of the active path's target server's heat score. This may ensure that particular conditions (e.g., CPU utilization, memory utilization, network latency, network utilization, etc.) currently utilized/experienced by the target servers are factored in when determining how many path groups to utilize and how much network traffic to route through each active path.

Process 1100 may be performed any suitable number of times as part of ongoing monitoring of established connections by the connection manager 1104. It should be appreciated that the operations of process 1100 may be performed in any suitable order. More or fewer operations may be performed different from the ones depicted in FIG. 11.

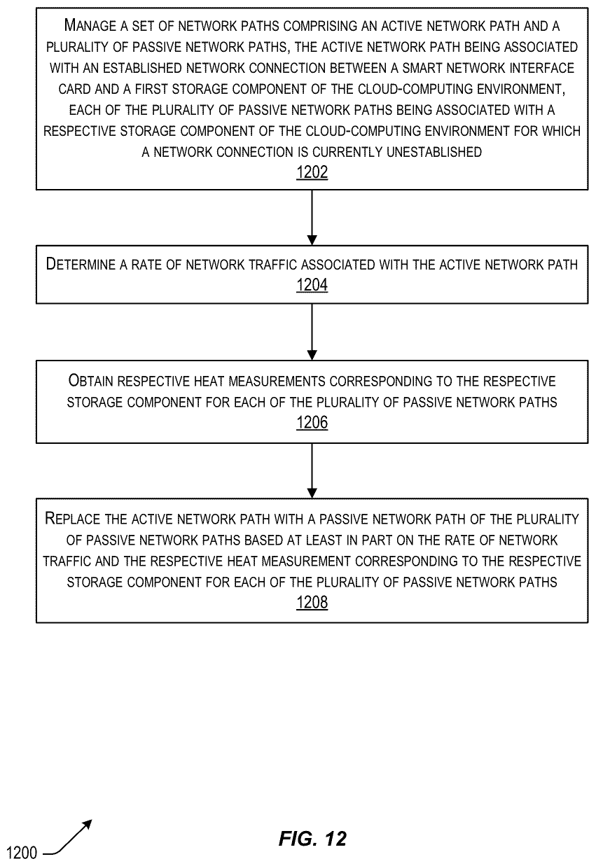

FIG. 12 is a diagram illustrating a method 1200 for managing network paths between a smartNIC and a storage data plane of a cloud computing environment, according to an embodiment. The method 1200 may be performed by any suitable component of a smart network interface card (e.g., smartNIC 802 of FIG. 8, smartNIC 910 of FIG. 9, smartNIC 1007 of FIG. 10, smartNIC 1107 of FIG. 11). By way of example, method 1200 may be performed by the connection manager 828 of FIG. 8. The operations of method 1200 may be performed in any suitable order and may include more or fewer operations than those depicted in FIG. 12.

The method 1200 may begin at 1202, where a software agent (e.g., the connection manager 828 of FIG. 8) may manage a set of network paths (e.g., paths 830 of FIG. 8) comprising an active network path and a plurality of passive network paths. Managing these network paths may include instructing an NVMe initiator (e.g., NVMe initiator 826 of FIG. 8) to establish and/or terminate connections to one or more targets corresponding to one or more network paths. In some embodiments, the active network path (e.g., path 830a of FIG. 8) may be associated with an established network connection between the smart network interface card (e.g., smartNIC 802) and a first storage component of the cloud-computing environment (e.g., target 814a of FIG. 8). Each of the plurality of passive network paths may be associated with a respective storage component of the cloud-computing environment for which a network connection is currently unestablished (e.g., target 814b and target 814c of FIG. 8, respectively).

At 1204, the software agent may determine a rate of network traffic associated with an active network path (e.g., the rate of network traffic for path 830a). By way of example, connection manager 828 may be configured to identify input/output operations of network traffic data (e.g., data indicating the network traffic is associated with an I/O operation, the data payload of the network traffic, the network traffic itself) obtained from the NVMe initiator 826. The number of input/output operations may correspond to a given namespace or path group (e.g., path group 832 comprising paths 830a-c) and may be determined for a given time period. As a non-limiting example, connection manager 828 may determine a number of Input/Output (I/O) operations passing through the paths of path group 832 per second (or another suitable time unit).

At 1206, the software agent may obtain heat measurements (e.g., CPU utilization values) corresponding to the respective storage component for each of the plurality of passive network paths (e.g., the heat measurements corresponding to targets 814b and 814c). In some embodiments, heat measurements may be expressed as a percentage of central processing unit utilization of a central processing unit of the respective storage component for each of the plurality of passive network paths. Any suitable heat measurements may be obtained for any suitable target (e.g., any suitable combination of targets 814a-c) at any suitable time. In some embodiments, a heat score (e.g., a normalized CPU utilization value), HS, may be calculated by the connection manager 828 for each target of a passive path (e.g., targets 814b and 814c in the ongoing example) by dividing the I/O operations rate (e.g., I/O operations per second (IOPS)) of the path group (PG) by the heat measurement of the target, heat(T), subtracted from 1. This calculation can be expressed by the formula:

$$HS = \frac{IOPS ( PG )}{1 - heat ( T )}$$

The larger the heat score is, the higher the chance that the corresponding target might underperform within the path group PG. Therefore, the connection manager 828 may be configured to select a passive path that has the lowest heat score for failover (e.g., target 814b).

In some embodiments, a heat score may be calculated for the active path (e.g., path 830a corresponding to target 814a) and heat measurements may be obtained for passive paths (e.g., targets 814b and 814c) when the heat score of the active path indicates that the active path has been compromised (e.g., that the heat score has breached a predefined threshold value). In other embodiments, heat scores may be periodically calculated for the active and passive paths regardless of whether the active path has been deemed to be compromised beforehand. These heat scores may be used to identify an optimal path to be utilized regardless of whether the current active path has been compromised or not.

At 1208, the software agent (e.g., connection manager 828) may replace the active network path (e.g., path 830a) with a passive network path (e.g., path 830b) of the plurality of passive network paths based at least in part on the rate of network traffic and the respective heat measurement corresponding to the respective storage component for each of the plurality of passive network paths. In other words, a passive network path with a lower heat score may be selected and used to replace the active network path. A first passive network path of the plurality of passive network paths may be selected over a second passive network path of the plurality of passive network paths based at least in part on determining that a first heat measurement corresponding to the first passive network path is less than a second heat measurement corresponding to the second passive network path. In some embodiments, replacing the active network path causes a new network connection associated with the passive network path to be established between the smart network interface card and another storage component of the cloud-computing environment. The previously established network connection between the smartNIC and a target corresponding to the active path may be terminated and marked as passive, the previously passive network path with the established connection may be marked as the active network path for the path group.

This method 1200 may be performed on an ongoing basis enabling the software agent to dynamically adjust the network traffic flow based on the CPU utilization of each of the targets. These techniques provide improvements over conventional methods by enabling the TCP connections utilized for a given BSDP volume or namespace to be dynamically modified (e.g., increased or decreased) to reduce the risk of delay and/or failures.

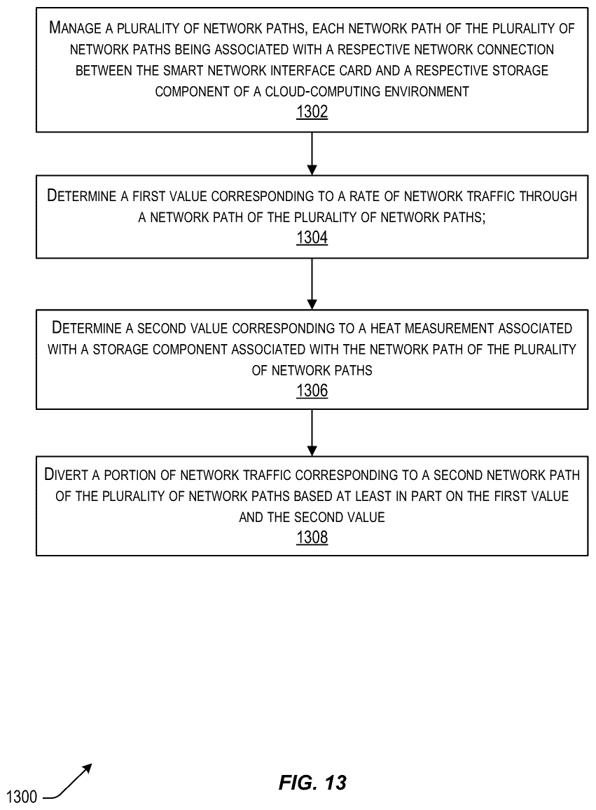

FIG. 13 is a block diagram illustrating another method 1300 for managing network paths between a smartNIC and a resource of a cloud computing environment, according to an embodiment. The method 1300 may be performed by any suitable component of a smart network interface card (e.g., smartNIC 802 of FIG. 8, smartNIC 910 of FIG. 9, smartNIC 1007 of FIG. 10, smartNIC 1107 of FIG. 11). By way of example, method 1300 may be performed by the connection manager 940 of FIG. 9. The operations of method 1300 may be performed in any suitable order and may include more or fewer operations than those depicted in FIG. 13.

The method 1300 may begin at 1302, where a software agent (e.g., the connection manager 940 of FIG. 9) may manage a plurality of network paths (e.g., paths 906 and 908 of FIG. 9 corresponding to a common namespace). Managing these network paths may include instructing an NVMe initiator (e.g., NVMe initiator 925 of FIG. 9) to establish and/or terminate connections to one or more targets corresponding to one or more network paths. In some embodiments, the active network path(s) (e.g., path 906a and path 906b of FIG. 9) may be associated with an established network connection between the smart network interface card (e.g., smartNIC 802) and a respective storage component of the cloud-computing environment (e.g., target 814a and target 814e of FIG. 8, respectively). Each of the plurality of passive network paths may be associated with a respective storage component of the cloud-computing environment for which a network connection is currently unestablished (e.g., targets 814b-d and 814f of FIG. 8, respectively). In this example, the network paths may correspond to multiple (e.g., two) path groups as depicted in FIG. 9.

At 1304, the software agent may determine a first value corresponding to a rate of network traffic through a network path of the plurality of network paths (e.g., the rate of network traffic for path 906b). This may include identifying a rate of network traffic corresponding to a path group (e.g., path group 902b of FIG. 9). The connection manager 940 may be configured to identify input/output operations of network traffic data (e.g., data indicating the network traffic is associated with an I/O operation, the data payload of the network traffic, the network traffic itself) obtained from the NVMe initiator 925. The number of input/output operations may correspond to a given namespace or path group (e.g., path group 902b) and may be determined for a given time period. As a non-limiting example, connection manager 925 may determine a number of Input/Output (I/O) operations passing through the paths of path group 902a per second (or another suitable time unit).

At 1306, the software agent may determine a second value corresponding to a heat measurement associated with a storage component associated with the network path of the plurality of network paths (e.g., one or more heat measurements corresponding to NVMe/TCP target servers 904e). By way of example, a heat measurement for NVMe/TCP target server 904e may be determined. This may include requesting or receiving, by the connection manager 940, heat measurements from NVMe target server 904e. In some embodiments, a heat score, HS, may be calculated by the connection manager 940 for each target for which a heat measurement has been determined by dividing the I/O operations rate (e.g., I/O operations per second (IOPS)) of the path group (PG) by the heat measurement of the target, heat(T), subtracted from 1. As described above, this calculation can be expressed by the formula:

$$HS = \frac{IOPS ( PG )}{1 - heat ( T )}$$

In some embodiments, a heat score may be calculated for active path 906b (and any suitable path for which heat measurements have been obtained such as passive paths 908a-d). In other embodiments, heat scores may be periodically calculated for the active and passive paths of one or more path groups, regardless of whether an active path of one path group has been deemed to be compromised beforehand. These heat scores may be used to identify an optimal path to be utilized, or a path to which to divert at least some network traffic, regardless of whether the current active path has been compromised or not.

At 1308, the software agent (e.g., connection manager 828) may divert at least a portion of the network traffic corresponding to a second network path of the plurality of network paths (e.g., active path 906a) based at least in part on the first value and the second value. By way of example, when a heat score associated with the active path 906a indicates that the active path has been compromised (e.g., a threshold number of network packets have been dropped, a heat score associated with the active path 906a exceeds a predefined threshold value, a last time a network packet was transmitted or received by the smartNIC 910 or NVMe/TCP target server 904a has exceeded a predetermined threshold period of time, the NVMe/TCP connection has been lost, etc.), at least some of the network traffic of the namespace through active path 906b. In some embodiments, active path 906b may be selected based on having a heat score that is lowest among the paths of path group 902a and 902b and/or active path 906b may be selected due to having a lower heat score than at least active path 906a. In situations in which a passive path of path groups 902a or 902b is determined to have a lowest heat score, operations may be executed by the connection manager 940 to instruct NVMe/TCP initiator 925 to modify the paths to activate a passive path (e.g., passive path 908c) and deactivate a previously active path (e.g., active path 906b). Once active, network traffic may be diverted from the active path 906a to the now active path (e.g., path 908c) to balance the CPU processing requirements for processinging network traffic across network paths.

This method 1300 may be performed on an ongoing basis enabling the software agent to dynamically adjust the network traffic flow based on the CPU usage by each of the targets. These techniques provide improvements over conventional methods by enabling the network connections utilized for a given BSDP volume or namespace to be dynamically modified (e.g., increased or decreased) to reduce the risk of degraded performance and related failures.

### IaaS Architecture Examples

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

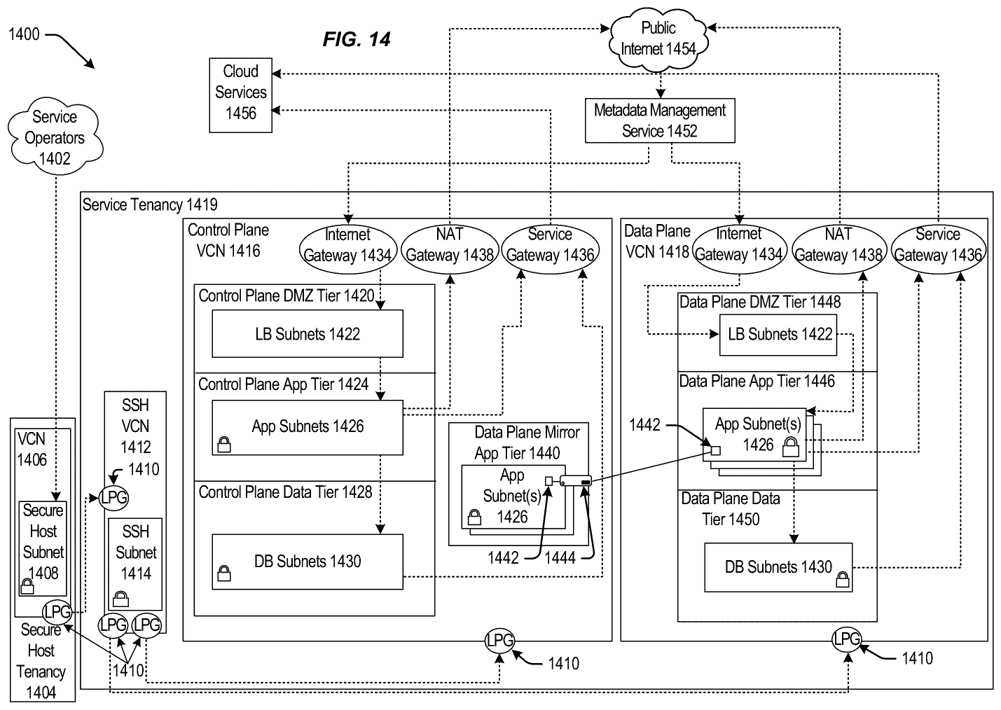

FIG. 14 is a block diagram 1400 illustrating an example pattern of an IaaS architecture, according to at least one embodiment. Service operators 1402 can be communicatively coupled to a secure host tenancy 1404 that can include a virtual cloud network (VCN) 1406 and a secure host subnet 1408. In some examples, the service operators 1402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1406 and/or the Internet.

The VCN 1406 can include a local peering gateway (LPG) 1410 that can be communicatively coupled to a secure shell (SSH) VCN 1412 via an LPG 1410 contained in the SSH VCN 1412. The SSH VCN 1412 can include an SSH subnet 1414, and the SSH VCN 1412 can be communicatively coupled to a control plane VCN 1416 via the LPG 1410 contained in the control plane VCN 1416. Also, the SSH VCN 1412 can be communicatively coupled to a data plane VCN 1418 via an LPG 1410. The control plane VCN 1416 and the data plane VCN 1418 can be contained in a service tenancy 1419 that can be owned and/or operated by the IaaS provider.

The control plane VCN 1416 can include a control plane demilitarized zone (DMZ) tier 1420 that acts as a perimeter network (e.g., portions of a corporate network between the corporate intranet and external networks). The DMZ-based servers may have restricted responsibilities and help keep breaches contained. Additionally, the DMZ tier 1420 can include one or more load balancer (LB) subnet(s) 1422, a control plane app tier 1424 that can include app subnet(s) 1426, a control plane data tier 1428 that can include database (DB) subnet(s) 1430 (e.g., frontend DB subnet(s) and/or backend DB subnet(s)). The LB subnet(s) 1422 contained in the control plane DMZ tier 1420 can be communicatively coupled to the app subnet(s) 1426 contained in the control plane app tier 1424 and an Internet gateway 1434 that can be contained in the control plane VCN 1416, and the app subnet(s) 1426 can be communicatively coupled to the DB subnet(s) 1430 contained in the control plane data tier 1428 and a service gateway 1436 and a network address translation (NAT) gateway 1438. The control plane VCN 1416 can include the service gateway 1436 and the NAT gateway 1438.

The control plane VCN 1416 can include a data plane mirror app tier 1440 that can include app subnet(s) 1426. The app subnet(s) 1426 contained in the data plane mirror app tier 1440 can include a virtual network interface controller (VNIC) 1442 that can execute a compute instance 1444. The compute instance 1444 can communicatively couple the app subnet(s) 1426 of the data plane mirror app tier 1440 to app subnet(s) 1426 that can be contained in a data plane app tier 1446.

The data plane VCN 1418 can include the data plane app tier 1446, a data plane DMZ tier 1448, and a data plane data tier 1450. The data plane DMZ tier 1448 can include LB subnet(s) 1422 that can be communicatively coupled to the app subnet(s) 1426 of the data plane app tier 1446 and the Internet gateway 1434 of the data plane VCN 1418. The app subnet(s) 1426 can be communicatively coupled to the service gateway 1436 of the data plane VCN 1418 and the NAT gateway 1438 of the data plane VCN 1418. The data plane data tier 1450 can also include the DB subnet(s) 1430 that can be communicatively coupled to the app subnet(s) 1426 of the data plane app tier 1446.

The Internet gateway 1434 of the control plane VCN 1416 and of the data plane VCN 1418 can be communicatively coupled to a metadata management service 1452 that can be communicatively coupled to public Internet 1454. Public Internet 1454 can be communicatively coupled to the NAT gateway 1438 of the control plane VCN 1416 and of the data plane VCN 1418. The service gateway 1436 of the control plane VCN 1416 and of the data plane VCN 1418 can be communicatively coupled to cloud services 1456.

In some examples, the service gateway 1436 of the control plane VCN 1416 or of the data plane VCN 1418 can make application programming interface (API) calls to cloud services 1456 without going through public Internet 1454. The API calls to cloud services 1456 from the service gateway 1436 can be one-way: the service gateway 1436 can make API calls to cloud services 1456, and cloud services 1456 can send requested data to the service gateway 1436. But, cloud services 1456 may not initiate API calls to the service gateway 1436.

In some examples, the secure host tenancy 1404 can be directly connected to the service tenancy 1419, which may be otherwise isolated. The secure host subnet 1408 can communicate with the SSH subnet 1414 through an LPG 1410 that may enable two-way communication over an otherwise isolated system. Connecting the secure host subnet 1408 to the SSH subnet 1414 may give the secure host subnet 1408 access to other entities within the service tenancy 1419.

The control plane VCN 1416 may allow users of the service tenancy 1419 to set up or otherwise provision desired resources. Desired resources provisioned in the control plane VCN 1416 may be deployed or otherwise used in the data plane VCN 1418. In some examples, the control plane VCN 1416 can be isolated from the data plane VCN 1418, and the data plane mirror app tier 1440 of the control plane VCN 1416 can communicate with the data plane app tier 1446 of the data plane VCN 1418 via VNICs 1442 that can be contained in the data plane mirror app tier 1440 and the data plane app tier 1446.

In some examples, users of the system, or customers, can make requests, for example create, read, update, or delete (CRUD) operations, through public Internet 1454 that can communicate the requests to the metadata management service 1452. The metadata management service 1452 can communicate the request to the control plane VCN 1416 through the Internet gateway 1434. The request can be received by the LB subnet(s) 1422 contained in the control plane DMZ tier 1420. The LB subnet(s) 1422 may determine that the request is valid, and in response to this determination, the LB subnet(s) 1422 can transmit the request to app subnet(s) 1426 contained in the control plane app tier 1424. If the request is validated and requires a call to public Internet 1454, the call to public Internet 1454 may be transmitted to the NAT gateway 1438 that can make the call to public Internet 1454. Metadata that may be desired to be stored by the request can be stored in the DB subnet(s) 1430.

In some examples, the data plane mirror app tier 1440 can facilitate direct communication between the control plane VCN 1416 and the data plane VCN 1418. For example, changes, updates, or other suitable modifications to configuration may be desired to be applied to the resources contained in the data plane VCN 1418. Via a VNIC 1442, the control plane VCN 1416 can directly communicate with, and can thereby execute the changes, updates, or other suitable modifications to configuration to, resources contained in the data plane VCN 1418.

In some embodiments, the control plane VCN 1416 and the data plane VCN 1418 can be contained in the service tenancy 1419. In this case, the user, or the customer, of the system may not own or operate either the control plane VCN 1416 or the data plane VCN 1418. Instead, the IaaS provider may own or operate the control plane VCN 1416 and the data plane VCN 1418, both of which may be contained in the service tenancy 1419. This embodiment can enable isolation of networks that may prevent users or customers from interacting with other users', or other customers', resources. Also, this embodiment may allow users or customers of the system to store databases privately without needing to rely on public Internet 1454, which may not have a desired level of threat prevention, for storage.

In other embodiments, the LB subnet(s) 1422 contained in the control plane VCN 1416 can be configured to receive a signal from the service gateway 1436. In this embodiment, the control plane VCN 1416 and the data plane VCN 1418 may be configured to be called by a customer of the IaaS provider without calling public Internet 1454. Customers of the IaaS provider may desire this embodiment since database(s) that the customers use may be controlled by the IaaS provider and may be stored on the service tenancy 1419, which may be isolated from public Internet 1454.

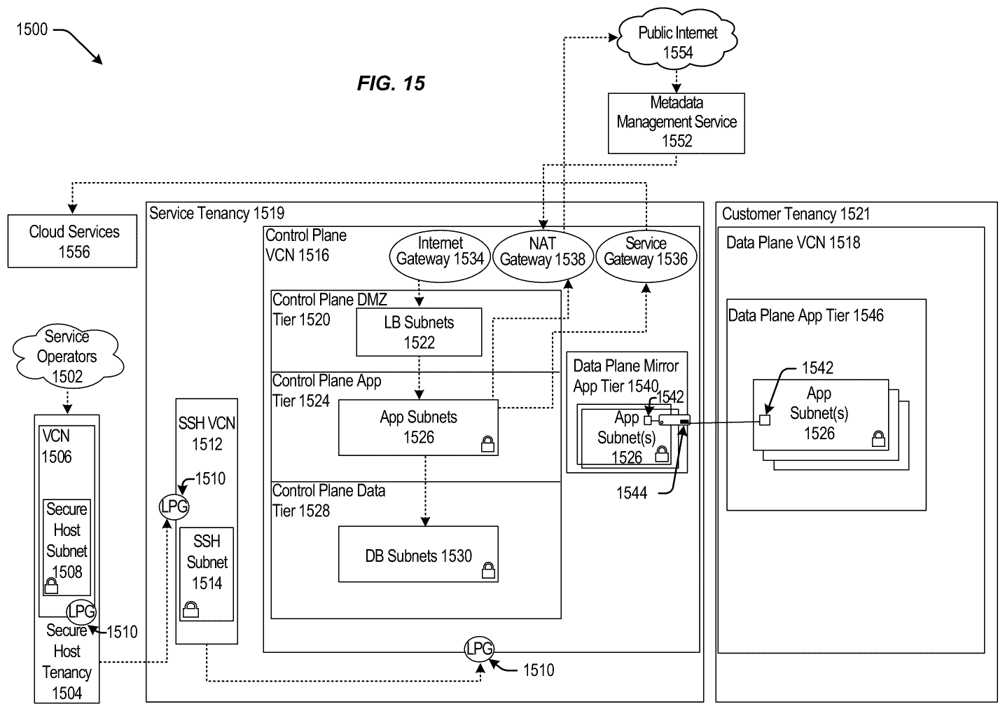

FIG. 15 is a block diagram 1500 illustrating another example pattern of an IaaS architecture, according to at least one embodiment. Service operators 1502 (e.g., service operators 1402 of FIG. 14) can be communicatively coupled to a secure host tenancy 1504 (e.g., the secure host tenancy 1404 of FIG. 14) that can include a virtual cloud network (VCN) 1506 (e.g., the VCN 1406 of FIG. 14) and a secure host subnet 1508 (e.g., the secure host subnet 1408 of FIG. 14). The VCN 1506 can include a local peering gateway (LPG) 1510 (e.g., the LPG 1410 of FIG. 14) that can be communicatively coupled to a secure shell (SSH) VCN 1512 (e.g., the SSH VCN 1412 of FIG. 14) via an LPG 1410 contained in the SSH VCN 1512. The SSH VCN 1512 can include an SSH subnet 1514 (e.g., the SSH subnet 1414 of FIG. 14), and the SSH VCN 1512 can be communicatively coupled to a control plane VCN 1516 (e.g., the control plane VCN 1416 of FIG. 14) via an LPG 1510 contained in the control plane VCN 1516. The control plane VCN 1516 can be contained in a service tenancy 1519 (e.g., the service tenancy 1419 of FIG. 14), and the data plane VCN 1518 (e.g., the data plane VCN 1418 of FIG. 14) can be contained in a customer tenancy 1521 that may be owned or operated by users, or customers, of the system.

The control plane VCN 1516 can include a control plane DMZ tier 1520 (e.g., the control plane DMZ tier 1420 of FIG. 14) that can include LB subnet(s) 1522 (e.g., LB subnet(s) 1422 of FIG. 14), a control plane app tier 1524 (e.g., the control plane app tier 1424 of FIG. 14) that can include app subnet(s) 1526 (e.g., app subnet(s) 1426 of FIG. 14), a control plane data tier 1528 (e.g., the control plane data tier 1428 of FIG. 14) that can include database (DB) subnet(s) 1530 (e.g., similar to DB subnet(s) 1430 of FIG. 14). The LB subnet(s) 1522 contained in the control plane DMZ tier 1520 can be communicatively coupled to the app subnet(s) 1526 contained in the control plane app tier 1524 and an Internet gateway 1534 (e.g., the Internet gateway 1434 of FIG. 14) that can be contained in the control plane VCN 1516, and the app subnet(s) 1526 can be communicatively coupled to the DB subnet(s) 1530 contained in the control plane data tier 1528 and a service gateway 1536 (e.g., the service gateway 1436 of FIG. 14) and a network address translation (NAT) gateway 1538 (e.g., the NAT gateway 1438 of FIG. 14). The control plane VCN 1516 can include the service gateway 1536 and the NAT gateway 1538.

The control plane VCN 1516 can include a data plane mirror app tier 1540 (e.g., the data plane mirror app tier 1440 of FIG. 14) that can include app subnet(s) 1526. The app subnet(s) 1526 contained in the data plane mirror app tier 1540 can include a virtual network interface controller (VNIC) 1542 (e.g., the VNIC of 1442) that can execute a compute instance 1544 (e.g., similar to the compute instance 1444 of FIG. 14). The compute instance 1544 can facilitate communication between the app subnet(s) 1526 of the data plane mirror app tier 1540 and the app subnet(s) 1526 that can be contained in a data plane app tier 1546 (e.g., the data plane app tier 1446 of FIG. 14) via the VNIC 1542 contained in the data plane mirror app tier 1540 and the VNIC 1542 contained in the data plane app tier 1546.

The Internet gateway 1534 contained in the control plane VCN 1516 can be communicatively coupled to a metadata management service 1552 (e.g., the metadata management service 1452 of FIG. 14) that can be communicatively coupled to public Internet 1554 (e.g., public Internet 1454 of FIG. 14). Public Internet 1554 can be communicatively coupled to the NAT gateway 1538 contained in the control plane VCN 1516. The service gateway 1536 contained in the control plane VCN 1516 can be communicatively coupled to cloud services 1556 (e.g., cloud services 1456 of FIG. 14).

In some examples, the data plane VCN 1518 can be contained in the customer tenancy 1521. In this case, the IaaS provider may provide the control plane VCN 1516 for each customer, and the IaaS provider may, for each customer, set up a unique compute instance 1544 that is contained in the service tenancy 1519. Each compute instance 1544 may allow communication between the control plane VCN 1516, contained in the service tenancy 1519, and the data plane VCN 1518 that is contained in the customer tenancy 1521. The compute instance 1544 may allow resources, that are provisioned in the control plane VCN 1516 that is contained in the service tenancy 1519, to be deployed or otherwise used in the data plane VCN 1518 that is contained in the customer tenancy 1521.

In other examples, the customer of the IaaS provider may have databases that live in the customer tenancy 1521. In this example, the control plane VCN 1516 can include the data plane mirror app tier 1540 that can include app subnet(s) 1526. The data plane mirror app tier 1540 can reside in the data plane VCN 1518, but the data plane mirror app tier 1540 may not live in the data plane VCN 1518. That is, the data plane mirror app tier 1540 may have access to the customer tenancy 1521, but the data plane mirror app tier 1540 may not exist in the data plane VCN 1518 or be owned or operated by the customer of the IaaS provider. The data plane mirror app tier 1540 may be configured to make calls to the data plane VCN 1518 but may not be configured to make calls to any entity contained in the control plane VCN 1516. The customer may desire to deploy or otherwise use resources in the data plane VCN 1518 that are provisioned in the control plane VCN 1516, and the data plane mirror app tier 1540 can facilitate the desired deployment, or other usage of resources, of the customer.

In some embodiments, the customer of the IaaS provider can apply filters to the data plane VCN 1518. In this embodiment, the customer can determine what the data plane VCN 1518 can access, and the customer may restrict access to public Internet 1554 from the data plane VCN 1518. The IaaS provider may not be able to apply filters or otherwise control access of the data plane VCN 1518 to any outside networks or databases. Applying filters and controls by the customer onto the data plane VCN 1518, contained in the customer tenancy 1521, can help isolate the data plane VCN 1518 from other customers and from public Internet 1554.

In some embodiments, cloud services 1556 can be called by the service gateway 1536 to access services that may not exist on public Internet 1554, on the control plane VCN 1516, or on the data plane VCN 1518. The connection between cloud services 1556 and the control plane VCN 1516 or the data plane VCN 1518 may not be live or continuous. Cloud services 1556 may exist on a different network owned or operated by the IaaS provider. Cloud services 1556 may be configured to receive calls from the service gateway 1536 and may be configured to not receive calls from public Internet 1554. Some cloud services 1556 may be isolated from other cloud services 1556, and the control plane VCN 1516 may be isolated from cloud services 1556 that may not be in the same region as the control plane VCN 1516. For example, the control plane VCN 1516 may be located in “Region 1,” and cloud service “Deployment 14,” may be located in Region 1 and in “Region 2.” If a call to Deployment 14 is made by the service gateway 1536 contained in the control plane VCN 1516 located in Region 1, the call may be transmitted to Deployment 14 in Region 1. In this example, the control plane VCN 1516, or Deployment 14 in Region 1, may not be communicatively coupled to, or otherwise in communication with, Deployment 14 in Region 2.

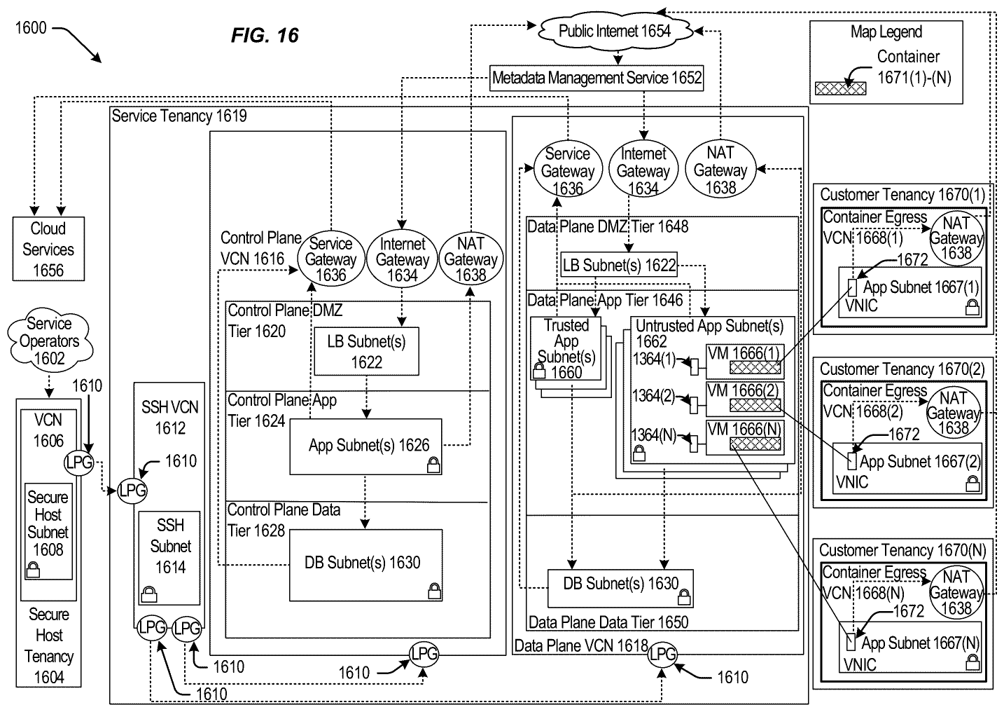

FIG. 16 is a block diagram 1600 illustrating another example pattern of an IaaS architecture, according to at least one embodiment. Service operators 1602 (e.g., service operators 1402 of FIG. 14) can be communicatively coupled to a secure host tenancy 1604 (e.g., the secure host tenancy 1404 of FIG. 14) that can include a virtual cloud network (VCN) 1606 (e.g., the VCN 1406 of FIG. 14) and a secure host subnet 1608 (e.g., the secure host subnet 1408 of FIG. 14). The VCN 1606 can include an LPG 1610 (e.g., the LPG 1410 of FIG. 14) that can be communicatively coupled to an SSH VCN 1612 (e.g., the SSH VCN 1412 of FIG. 14) via an LPG 1610 contained in the SSH VCN 1612. The SSH VCN 1612 can include an SSH subnet 1614 (e.g., the SSH subnet 1414 of FIG. 14), and the SSH VCN 1612 can be communicatively coupled to a control plane VCN 1616 (e.g., the control plane VCN 1416 of FIG. 14) via an LPG 1610 contained in the control plane VCN 1616 and to a data plane VCN 1618 (e.g., the data plane 1418 of FIG. 14) via an LPG 1610 contained in the data plane VCN 1618. The control plane VCN 1616 and the data plane VCN 1618 can be contained in a service tenancy 1619 (e.g., the service tenancy 1419 of FIG. 14).

The control plane VCN 1616 can include a control plane DMZ tier 1620 (e.g., the control plane DMZ tier 1420 of FIG. 14) that can include load balancer (LB) subnet(s) 1622 (e.g., LB subnet(s) 1422 of FIG. 14), a control plane app tier 1624 (e.g., the control plane app tier 1424 of FIG. 14) that can include app subnet(s) 1626 (e.g., similar to app subnet(s) 1426 of FIG. 14), a control plane data tier 1628 (e.g., the control plane data tier 1428 of FIG. 14) that can include DB subnet(s) 1630. The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1434 of FIG. 14) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 14) and a network address translation (NAT) gateway 1638 (e.g., the NAT gateway 1438 of FIG. 14). The control plane VCN 1616 can include the service gateway 1636 and the NAT gateway 1638.

The data plane VCN 1618 can include a data plane app tier 1646 (e.g., the data plane app tier 1446 of FIG. 14), a data plane DMZ tier 1648 (e.g., the data plane DMZ tier 1448 of FIG. 14), and a data plane data tier 1650 (e.g., the data plane data tier 1450 of FIG. 14). The data plane DMZ tier 1648 can include LB subnet(s) 1622 that can be communicatively coupled to trusted app subnet(s) 1660 and untrusted app subnet(s) 1662 of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include one or more primary VNICs 1664(1)-(N) that can be communicatively coupled to tenant virtual machines (VMs) 1666(1)-(N). Each tenant VM 1666(1)-(N) can be communicatively coupled to a respective app subnet 1667(1)-(N) that can be contained in respective container egress VCNs 1668(1)-(N) that can be contained in respective customer tenancies 1670(1)-(N). Respective secondary VNICs 1672(1)-(N) can facilitate communication between the untrusted app subnet(s) 1662 contained in the data plane VCN 1618 and the app subnet contained in the container egress VCNs 1668(1)-(N). Each container egress VCNs 1668(1)-(N) can include a NAT gateway 1638 that can be communicatively coupled to public Internet 1654 (e.g., public Internet 1454 of FIG. 14).

The Internet gateway 1634 contained in the control plane VCN 1616 and contained in the data plane VCN 1618 can be communicatively coupled to a metadata management service 1652 (e.g., the metadata management system 1452 of FIG. 14) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some embodiments, the data plane VCN 1618 can be integrated with customer tenancies 1670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1646. Code to run the function may be executed in the VMs 1666(1)-(N), and the code may not be configured to run anywhere else on the data plane VCN 1618. Each VM 1666(1)-(N) may be connected to one customer tenancy 1670. Respective containers 1671(1)-(N) contained in the VMs 1666(1)-(N) may be configured to run the code. In this case, there can be a dual isolation (e.g., the containers 1671(1)-(N) running code, where the containers 1671(1)-(N) may be contained in at least the VM 1666(1)-(N) that are contained in the untrusted app subnet(s) 1662), which may help prevent incorrect or otherwise undesirable code from damaging the network of the IaaS provider or from damaging a network of a different customer. The containers 1671(1)-(N) may be communicatively coupled to the customer tenancy 1670 and may be configured to transmit or receive data from the customer tenancy 1670. The containers 1671(1)-(N) may not be configured to transmit or receive data from any other entity in the data plane VCN 1618. Upon completion of running the code, the IaaS provider may kill or otherwise dispose of the containers 1671(1)-(N).

In some embodiments, the trusted app subnet(s) 1660 may run code that may be owned or operated by the IaaS provider. In this embodiment, the trusted app subnet(s) 1660 may be communicatively coupled to the DB subnet(s) 1630 and be configured to execute CRUD operations in the DB subnet(s) 1630. The untrusted app subnet(s) 1662 may be communicatively coupled to the DB subnet(s) 1630, but in this embodiment, the untrusted app subnet(s) may be configured to execute read operations in the DB subnet(s) 1630. The containers 1671(1)-(N) that can be contained in the VM 1666(1)-(N) of each customer and that may run code from the customer may not be communicatively coupled with the DB subnet(s) 1630.

In other embodiments, the control plane VCN 1616 and the data plane VCN 1618 may not be directly communicatively coupled. In this embodiment, there may be no direct communication between the control plane VCN 1616 and the data plane VCN 1618. However, communication can occur indirectly through at least one method. An LPG 1610 may be established by the IaaS provider that can facilitate communication between the control plane VCN 1616 and the data plane VCN 1618. In another example, the control plane VCN 1616 or the data plane VCN 1618 can make a call to cloud services 1656 via the service gateway 1636. For example, a call to cloud services 1656 from the control plane VCN 1616 can include a request for a service that can communicate with the data plane VCN 1618.

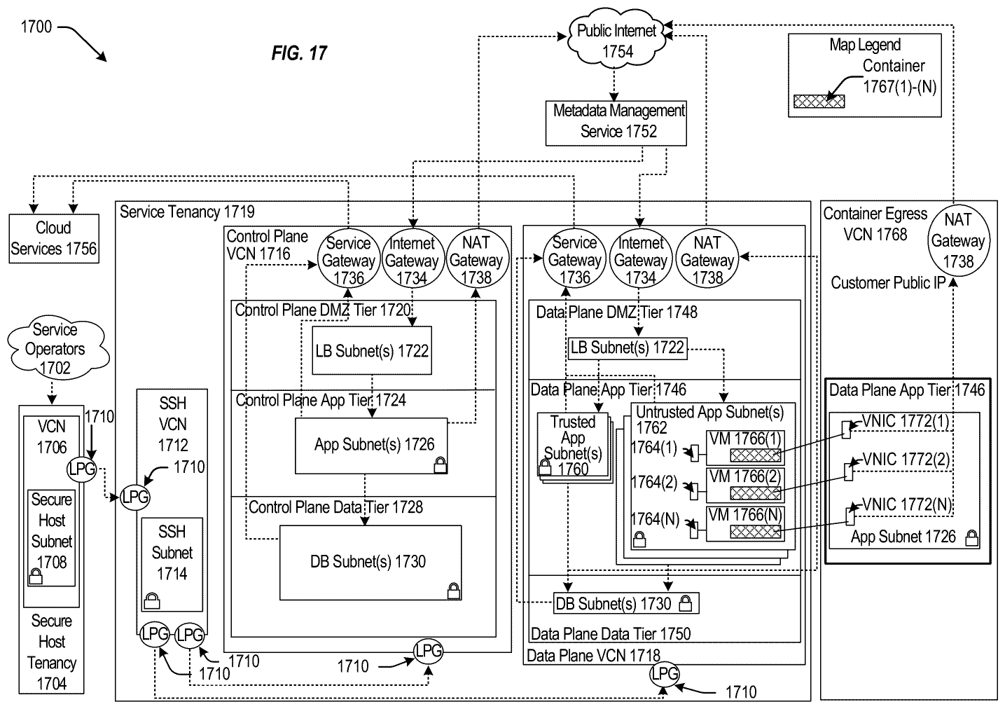

FIG. 17 is a block diagram 1700 illustrating another example pattern of an IaaS architecture, according to at least one embodiment. Service operators 1702 (e.g., service operators 1402 of FIG. 14) can be communicatively coupled to a secure host tenancy 1704 (e.g., the secure host tenancy 1404 of FIG. 14) that can include a virtual cloud network (VCN) 1706 (e.g., the VCN 1406 of FIG. 14) and a secure host subnet 1708 (e.g., the secure host subnet 1408 of FIG. 14). The VCN 1706 can include an LPG 1710 (e.g., the LPG 1410 of FIG. 14) that can be communicatively coupled to an SSH VCN 1712 (e.g., the SSH VCN 1412 of FIG. 14) via an LPG 1710 contained in the SSH VCN 1712. The SSH VCN 1712 can include an SSH subnet 1714 (e.g., the SSH subnet 1414 of FIG. 14), and the SSH VCN 1712 can be communicatively coupled to a control plane VCN 1716 (e.g., the control plane VCN 1416 of FIG. 14) via an LPG 1710 contained in the control plane VCN 1716 and to a data plane VCN 1718 (e.g., the data plane 1418 of FIG. 14) via an LPG 1710 contained in the data plane VCN 1718. The control plane VCN 1716 and the data plane VCN 1718 can be contained in a service tenancy 1719 (e.g., the service tenancy 1419 of FIG. 14).

The control plane VCN 1716 can include a control plane DMZ tier 1720 (e.g., the control plane DMZ tier 1420 of FIG. 14) that can include LB subnet(s) 1722 (e.g., LB subnet(s) 1422 of FIG. 14), a control plane app tier 1724 (e.g., the control plane app tier 1424 of FIG. 14) that can include app subnet(s) 1726 (e.g., app subnet(s) 1426 of FIG. 14), a control plane data tier 1728 (e.g., the control plane data tier 1428 of FIG. 14) that can include DB subnet(s) 1730 (e.g., DB subnet(s) 1630 of FIG. 16). The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1434 of FIG. 14) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 14) and a network address translation (NAT) gateway 1738 (e.g., the NAT gateway 1438 of FIG. 14). The control plane VCN 1716 can include the service gateway 1736 and the NAT gateway 1738.

The data plane VCN 1718 can include a data plane app tier 1746 (e.g., the data plane app tier 1446 of FIG. 14), a data plane DMZ tier 1748 (e.g., the data plane DMZ tier 1448 of FIG. 14), and a data plane data tier 1750 (e.g., the data plane data tier 1450 of FIG. 14). The data plane DMZ tier 1748 can include LB subnet(s) 1722 that can be communicatively coupled to trusted app subnet(s) 1760 (e.g., trusted app subnet(s) 1660 of FIG. 16) and untrusted app subnet(s) 1762 (e.g., untrusted app subnet(s) 1662 of FIG. 16) of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include primary VNICs 1764(1)-(N) that can be communicatively coupled to tenant virtual machines (VMs) 1766(1)-(N) residing within the untrusted app subnet(s) 1762. Each tenant VM 1766(1)-(N) can run code in a respective container 1767(1)-(N) and be communicatively coupled to an app subnet 1726 that can be contained in a data plane app tier 1746 that can be contained in a container egress VCN 1768. Respective secondary VNICs 1772(1)-(N) can facilitate communication between the untrusted app subnet(s) 1762 contained in the data plane VCN 1718 and the app subnet contained in the container egress VCN 1768. The container egress VCN can include a NAT gateway 1738 that can be communicatively coupled to public Internet 1754 (e.g., public Internet 1454 of FIG. 14).

The Internet gateway 1734 contained in the control plane VCN 1716 and contained in the data plane VCN 1718 can be communicatively coupled to a metadata management service 1752 (e.g., the metadata management system 1452 of FIG. 14) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively coupled to cloud services 1756.

In some examples, the pattern illustrated by the architecture of block diagram 1700 of FIG. 17 may be considered an exception to the pattern illustrated by the architecture of block diagram 1600 of FIG. 16 and may be desirable for a customer of the IaaS provider if the IaaS provider cannot directly communicate with the customer (e.g., a disconnected region). The respective containers 1767(1)-(N) that are contained in the VMs 1766(1)-(N) for each customer can be accessed in real-time by the customer. The containers 1767(1)-(N) may be configured to make calls to respective secondary VNICs 1772(1)-(N) contained in app subnet(s) 1726 of the data plane app tier 1746 that can be contained in the container egress VCN 1768. The secondary VNICs 1772(1)-(N) can transmit the calls to the NAT gateway 1738 that may transmit the calls to public Internet 1754. In this example, the containers 1767(1)-(N) that can be accessed in real-time by the customer can be isolated from the control plane VCN 1716 and can be isolated from other entities contained in the data plane VCN 1718. The containers 1767(1)-(N) may also be isolated from resources from other customers.

In other examples, the customer can use the containers 1767(1)-(N) to call cloud services 1756. In this example, the customer may run code in the containers 1767(1)-(N) that requests a service from cloud services 1756. The containers 1767(1)-(N) can transmit this request to the secondary VNICs 1772(1)-(N) that can transmit the request to the NAT gateway that can transmit the request to public Internet 1754. Public Internet 1754 can transmit the request to LB subnet(s) 1722 contained in the control plane VCN 1716 via the Internet gateway 1734. In response to determining the request is valid, the LB subnet(s) can transmit the request to app subnet(s) 1726 that can transmit the request to cloud services 1756 via the service gateway 1736.

It should be appreciated that IaaS architectures 1400, 1500, 1600, 1700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

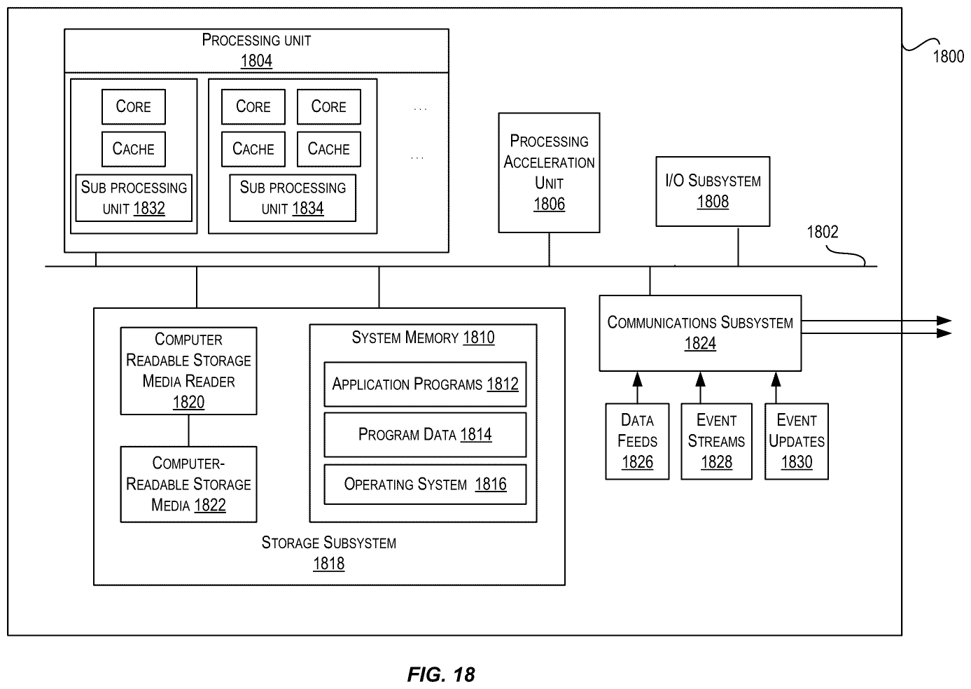

FIG. 18 illustrates an example computer system 1800, in which various embodiments may be implemented. The system 1800 may be used to implement any of the computer systems described above. As shown in the figure, computer system 1800 includes a processing unit 1804 that communicates with a number of peripheral subsystems via a bus subsystem 1802. These peripheral subsystems may include a processing acceleration unit 1806, an I/O subsystem 1808, a storage subsystem 1818 and a communications subsystem 1824. Storage subsystem 1818 includes tangible computer-readable storage media 1822 and a system memory 1810.

Bus subsystem 1802 provides a mechanism for letting the various components and subsystems of computer system 1800 communicate with each other as intended. Although bus subsystem 1802 is shown schematically as a single bus, alternative embodiments of the bus subsystem may utilize multiple buses. Bus subsystem 1802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1804, which can be implemented as one or more integrated circuits (e.g., a conventional microprocessor or microcontroller), controls the operation of computer system 1800. One or more processors may be included in processing unit 1804. These processors may include single core or multicore processors. In certain embodiments, processing unit 1804 may be implemented as one or more independent processing units 1832 and/or 1834 with single or multicore processors included in each processing unit. In other embodiments, processing unit 1804 may also be implemented as a quad-core processing unit formed by integrating two dual-core processors into a single chip.

In various embodiments, processing unit 1804 can execute a variety of programs in response to program code and can maintain multiple concurrently executing programs or processes. At any given time, some or all of the program code to be executed can be resident in processor(s) 1804 and/or in storage subsystem 1818. Through suitable programming, processor(s) 1804 can provide various functionalities described above. Computer system 1800 may additionally include a processing acceleration unit 1806, which can include a digital signal processor (DSP), a special-purpose processor, and/or the like.

I/O subsystem 1808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1800 may comprise a storage subsystem 1818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1804 provide the functionality described above. Storage subsystem 1818 may also provide a repository for storing data used in accordance with the present disclosure.

As depicted in the example in FIG. 18, storage subsystem 1818 can include various components including a system memory 1810, computer-readable storage media 1822, and a computer readable storage media reader 1820. System memory 1810 may store program instructions that are loadable and executable by processing unit 1804. System memory 1810 may also store data that is used during the execution of the instructions and/or data that is generated during the execution of the program instructions. Various different kinds of programs may be loaded into system memory 1810 including but not limited to client applications, Web browsers, mid-tier applications, relational database management systems (RDBMS), virtual machines, containers, etc.

System memory 1810 may also store an operating system 1816. Examples of operating system 1816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1800 executes one or more virtual machines, the virtual machines along with their guest operating systems (GOSs) may be loaded into system memory 1810 and executed by one or more processors or cores of processing unit 1804.

System memory 1810 can come in different configurations depending upon the type of computer system 1800. For example, system memory 1810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1810 may include a basic input/output system (BIOS) containing basic routines that help to transfer information between elements within computer system 1800, such as during start-up.

Computer-readable storage media 1822 may represent remote, local, fixed, and/or removable storage devices plus storage media for temporarily and/or more permanently containing, storing, computer-readable information for use by computer system 1800 including instructions executable by processing unit 1804 of computer system 1800.

Computer-readable storage media 1822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1822 may include, but is not limited to, Zip® drives, flash memory cards, universal serial bus (USB) flash drives, secure digital (SD) cards, DVD disks, digital video tape, and the like. Computer-readable storage media 1822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1800.

Machine-readable instructions executable by one or more processors or cores of processing unit 1804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1824 provides an interface to other computer systems and networks. Communications subsystem 1824 serves as an interface for receiving data from and transmitting data to other systems from computer system 1800. For example, communications subsystem 1824 may enable computer system 1800 to connect to one or more devices via the Internet. In some embodiments communications subsystem 1824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1824 can provide wired network connectivity (e.g., Ethernet) in addition to or instead of a wireless interface.

In some embodiments, communications subsystem 1824 may also receive input communication in the form of structured and/or unstructured data feeds 1826, event streams 1828, event updates 1830, and the like on behalf of one or more users who may use computer system 1800.

By way of example, communications subsystem 1824 may be configured to receive data feeds 1826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1824 may also be configured to receive data in the form of continuous data streams, which may include event streams 1828 of real-time events and/or event updates 1830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1824 may also be configured to output the structured and/or unstructured data feeds 1826, event streams 1828, event updates 1830, and the like to one or more databases that may be in communication with one or more streaming data source computers coupled to computer system 1800.

Computer system 1800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
managing, by a software agent at a smart network interface card of a cloud-computing environment, a set of network paths comprising an active network path and a plurality of passive network paths, the active network path being associated with an established network connection between the smart network interface card and a first storage component of the cloud-computing environment, each of the plurality of passive network paths being associated with a respective storage component of the cloud-computing environment for which a network connection is currently unestablished;
determining, by the software agent executing at the smart network interface card, a rate of network traffic associated with the active network path;
obtaining, by the software agent, respective heat measurements corresponding to the respective storage component for each of the plurality of passive network paths; and
replacing, by the software agent executing at the smart network interface card, the active network path with a passive network path of the plurality of passive network paths based at least in part on the rate of network traffic and the respective heat measurement corresponding to the respective storage component for each of the plurality of passive network paths, wherein replacing the active network path causes a new network connection associated with the passive network path to be established between the smart network interface card and another storage component of the cloud-computing environment.

2. The method of claim 1, wherein replacing the active network path further comprises terminating the established network connection between the smart network interface card and the first storage component.

3. The method of claim 1, wherein the respective heat measurements correspond to a percentage of central processing unit utilization of a central processing unit of the respective storage component for each of the plurality of passive network paths.

4. The method of claim 1, wherein the active network path is replaced based at least in part on detecting that the established network connection between the smart network interface card and the first storage component has failed.

5. The method of claim 1, further comprising selecting a first passive network path of the plurality of passive network paths to replace the active network path, the first passive network path being selected over a second passive network path of the plurality of passive network paths based at least in part on determining that a first heat measurement corresponding to the first passive network path is less than a second heat measurement corresponding to the second passive network path.

6. The method of claim 1, further comprising:
obtaining, by the software agent, a heat measurement for the active network path; and
calculating, by the software agent, a heat score for the active network path, the heat score being calculated based at least in part on dividing the rate of network traffic by the heat measurement for the active network path, wherein the active network path is replaced based at least in part on determining that the heat score for the active network path exceeds a predefined threshold value.

7. A smart network interface card, comprising:
one or more processors; and
one or more memories configured to store computer-executable instructions that, when executed by the one or more processors, cause the one or more processors to execute operations comprising:
managing a set of network paths comprising an active network path and a plurality of passive network paths, the active network path being associated with an established network connection between the smart network interface card and a first storage component of a cloud-computing environment, each of the plurality of passive network paths being associated with a respective storage component of the cloud-computing environment for which a network connection has yet to be established;
determining a rate of network traffic associated with the active network path;
obtaining respective heat measurements corresponding to the respective storage component for each of the plurality of passive network paths; and
replacing the active network path with a passive network path of the plurality of passive network paths based at least in part on the rate of network traffic and the respective heat measurement corresponding to the respective storage component for each of the plurality of passive network paths, wherein replacing the active network path causes a new network connection associated with the passive network path to be established between the smart network interface card and another storage component of the cloud-computing environment.

8. The smart network interface card of claim 7, wherein the operations are executed by a software agent of the smart network interface card.

9. The smart network interface card of claim 7, wherein executing the computer-executable instructions further causes the one or more processors to:
calculate a first heat score for a first passive network path of the plurality of passive network paths, the first heat score being calculated based at least in part on the rate of network traffic and a first heat measurement of the respective heat measurements, the first heat measurement corresponding to a second storage component of the cloud-computing environment; and
calculate a second heat score for a second passive network path of the plurality of passive network paths, the second heat score being calculated based at least in part on the rate of network traffic and a second heat measurement of the respective heat measurements, the second heat measurement corresponding to a third storage component of the cloud-computing environment;
wherein the passive network path that replaces the active network path is identified as the first passive network path based at least in part on the first heat score and the second heat ratio.

10. The smart network interface card of claim 7, wherein the respective heat measurements are obtained based at least in part on obtaining respective central processing unit utilization values corresponding to the respective storage component for each of the plurality of passive network paths.

11. A method, comprising:
managing, by a software agent executing at a smart network interface card, a plurality of network paths, each network path of the plurality of network paths being associated with a respective network connection between the smart network interface card and a respective storage component of a cloud-computing environment;
determining, by the software agent, a first value corresponding to a rate of network traffic through a network path of the plurality of network paths;
determining, by the software agent, a second value corresponding to a heat measurement associated with a storage component associated with the network path of the plurality of network paths; and
diverting, by the software agent to the network path of the plurality of network paths, a portion of network traffic corresponding to a second network path of the plurality of network paths based at least in part on the first value and the second value.

12. The method of claim 11, further comprising:
determining, by the software agent, a third value corresponding to a second rate of network traffic through the second network path; and
determining, by the software agent, a fourth value corresponding to a second heat measurement associated with a second storage component associated with the second network path;
wherein diverting the portion of network traffic is further based at least in part on the third value and the fourth value.

13. The method of claim 11, further comprising:
determining, by the software agent, a third value corresponding to a second rate of network traffic through a third network path of the plurality of network paths; and
determining, by the software agent, a fourth value corresponding to a second heat measurement associated with a second storage component associated with the third network path;
wherein diverting the portion of network traffic is further based at least in part on the third value and the fourth value.

14. The method of claim 11, wherein each of the plurality of network paths is an active network path of a respective network path group, the respective network path group further comprising one or more passive network paths, each of the one or more passive network paths being associated with a corresponding network connection between the smart network interface card and a corresponding storage component of the cloud-computing environment, the respective network connection being unestablished.

15. The method of claim 11, wherein each of the plurality of network paths is an active network path associated with a corresponding network path group of a plurality of network path groups, the active network path having an established network connection between the smart network interface card and a corresponding storage component of the cloud-computing environment.

16. A smart network interface card, comprising:
one or more processors; and
one or more memories configured to store computer-executable instructions that, when executed by the one or more processors, cause the one or more processors to execute operations comprising:
managing a plurality of network paths, each network path of the plurality of network paths being associated with a respective network connection between the smart network interface card and a respective storage component of a cloud-computing environment;
determining a first value corresponding to a rate of network traffic through a network path of the plurality of network paths;
determining a second value corresponding to a heat measurement associated with a storage component associated with the network path of the plurality of network paths; and
diverting, to the network path of the plurality of network paths, a portion of network traffic corresponding to a second network path of the plurality of network paths based at least in part on the first value and the second value.

17. The smart network interface card of claim 16, wherein the operations further comprise receiving, from an initiator of the smart network interface card, an indicator that the second network path of the plurality of network paths has failed, and wherein the second value corresponding to the heat measurement associated with the storage component is determined based at least in part on receiving the indicator.

18. The smart network interface card of claim 16, wherein the second network path is an active network path of a network path group, and wherein the network path to which the portion of network traffic is diverted is a passive network path of the network path group.

19. The smart network interface card of claim 16, wherein the second network path is a first active network path of a first network path group, and wherein the network path to which the portion of network traffic is diverted is a second active network path of a second network path group.

20. The smart network interface card of claim 16, wherein the operations further comprise determining an amount corresponding to the portion of network traffic diverted to the second network path based at least in part on a second amount of network traffic previously associated with the second network path.
